(19) United States
(12) Patent Application Publication
(10) Pub. No.: US 2004/0133581 A1
(43) Pub. Date: Jul. 8, 2004

(54) Database management system, data structure generating method for database management system, and storage medium therefor

(75) Inventor: Toshio Shinjo, Chiba-shi (JP)

Correspondence Address: FOLEY AND LARDNER, SUITE 500, 3000 K STREET NW, WASHINGTON, DC, 20007, US

(73) Assignee: High-Speed Engineering Laboratory, Inc.

(21) Appl. No.: 10/682,734

(22) Filed: Oct. 10, 2003

Related U.S. Application Data
(63) Continuation-in-part of application No. 10/408,129, filed on Apr. 8, 2003, now abandoned.
Application No. 10/408,129 is a continuation of application No. 10/345,210, filed on Jan. 16, 2003, now abandoned.
(60) Provisional application No. 60/384,409, filed on Jun. 3, 2002.
(60) Provisional application No. 60/381,782, filed on May 21, 2002.

(51) Int. Cl. G06F 17/00

(52) U.S. Cl. 707/100

(57) ABSTRACT

A database management system includes an object conversion unit converting each of a plurality of natural objects and each of a plurality of object IDs of consecutive data according to a predetermined rule in a unique relationship and a bidirectional manner; and a database storing tables of a hierarchical structure including the object IDs converted by said object conversion unit as a permanent object holding data during a period. The tables of the hierarchical structure have a data structure formed by connecting a lower table and another lower table through at least one upper table on a chain and in a bidirectional manner.

### CROSS REFERENCE

This patent application is a Continuation in part application of the previous U.S. patent application, titled “DATABASE MANAGEMENT SYSTEM, METHOD, AND STORAGE MEDIUM THEREFOR”, filed on Jan. 16, 2003, application Ser. No. 10/345,210 and filed on Apr. 8, 2003, application Ser. No. 10/408,129, herein incorporated by reference.

### BACKGROUND OF THE INVENTION

1. Technical Field

The present invention relates to a database system, and more specifically to a database management system, a data structure generating method for use with the database management system, and a storage medium storing data to be processed in the database management system.

2. Background Art

In a file system for managing data using an external storage device such as a floppy disk, a hard disk, CD-ROM, etc. through a user interface in each computer, data cannot be shared as resources in each department of a large organization such as a government office or a private enterprise. Therefore, based on a data-oriented approach centering the data resources in the system, there has been an increasing number of database systems capable of sharing data using a plurality of different user interfaces.

The type of database system can be a hierarchical database system, a network database system, a relational database system, an object-oriented database system, etc. Among them, a relational database system can be easily composed by comprehensible logic, and its data manipulations can be simply realized without knowledge of the data structure of the database. Therefore, it has been the most popular system especially in the business world.

FIG. 1 shows the concept of the configuration of a database management system 100 in a general relational database system. The database management system 100 comprises a database 101 for storing data, a processing unit 102 for performing data manipulations of the database 101, etc. When the database management system 100 receives a process request from a user interface or an application (hereinafter referred to as a user interface 110) of a sales subdepartment, a personnel subdepartment, a financial subdepartment, etc. of an enterprise, accesses the database 101, and performs data manipulations such as storing, adding, updating, and referencing data.

SQL is a database language used when a user accesses the database management system 100 through the user interface 110, and in 1987 was internationally standardized. The database management system 100 provides a service depending on the process request in the SQL statement input from the user interface 110.

When a relational database is generated, conceptual design, logical design, and physical design are required. In each designing process, a model of a set of data structure describing a data format, data relation, integrity constraint, etc. is generated as a schema. In the conceptual design, a concept model is generated by describing a part of a target real world in predetermined notation. In the logical design, a logical model is generated using a table, an index, and a data structure viewed from the user interface 110 (referred to as a “view”) as a logical data structure of a practical database model. In the physical design, the representation format of the storage device of a hard disk, etc., a file organization, an access method, contents of data, etc. are determined.

In the conceptual design, an entity relationship model (E-R model) is frequently used in representing a model of a target real world. In the entity relationship model, there are two concepts, that is, an “entity” and a “relation”. An entity refers to an inclusive description of an object to be recognized when a database designer designs a model of a target real world. Various characteristics of an entity are represented by “attributes”. A relation refers to a model of the correlation between two or more entities.

FIG. 2 shows an example of an entity relationship model in the relational database of a typical sized sales company. Among the three entities shown in FIG. 2, that is, an order E1, a client E2, and merchandise E3, the order E1 and the client E2 are associated with sales R1, and the order E1 and the merchandise E3 are associated with sales amount R2. The attributes of the order E1 can be a date A11, a client name A12, a merchandise name A13, and a number of pieces A14. The attributes of the client E2 can be a client name A21, an address A22, and a staff name A23. The attributes of merchandise E3 can be a merchandise name A31 and a unit price A32.

FIG. 3A shows the data structure implemented on a database based on the entity relationship model shown in FIG. 2. As shown in FIG. 3A, each entity shown in FIG. 2 is represented by a “row” (also referred to as a “record”) which is a horizontal data array and a “column” (also referred to as a “field” storing attribute data) which is a vertical data array. An order table 210 comprises a plurality of columns each comprising a date 211, a client name 212, a merchandise name 213, and a number of pieces 214. A client table 220 comprises a plurality of columns comprising a client name 221, an address 222, and a staff name 223. A merchandise table 230 comprises two columns including a merchandise name 231 and a unit price 232. For simple explanation, the number of rows shown in FIG. 3A is set to the smallest possible number. However, the number of rows of each table and the number of characters in each column are actually larger. Especially, the number of rows of an order table whose number of rows becomes large with an increasing number of orders. Practically, since it possibly reaches several millions of rows, a new block is normally prepared for a predetermined amount of data so that data can be stored in the new block when the current block becomes full of data.

The data implemented in the database 101 can be recognized by the user interface 110, that is, the data in the real world recognized by users. The above-mentioned data used in the real world is referred to as a “natural object”. In the example shown in FIG. 3A, the data of a 3-character client name comprises a 3-byte (24 bits) natural object, the data of a 6-character merchandise name comprises a 6-byte (48 bits) natural object, and the data of a 7-character address comprises 7 bytes (56 bits).

The reference information in the columns of each table is referred to as a “key”. Among a plurality of columns in a table, a column which can be a key is referred to as a “candidate key”. Furthermore, among a plurality of candidate keys, one or more columns which can uniquely identify each row of a table is referred to as a “primary key”. Therefore, in each table, there are no double primary keys, or NULL (no data) is not permitted. For example, in the client table 220, the client name 221 is a primary key, and the merchandise name 231 is the primary key in the merchandise table 230. A key referring to a row in another table is referred to as an “foreign key”. Using the foreign key, a primary key in another table can be referred to so that a target row can be retrieved.

That is, a primary key is a unique column specifying a row in a table, and a foreign key matches a primary key in another table which have reference relationship. Therefore, as shown in FIG. 3B, the foreign key of the column A2 in a row in the table A refers to the primary key B1 in a row in the table B. The foreign key in the column A5 in a row in the table A refers to the primary key C1 in a row in the table C. The foreign key in the column B3 in a row in the table B refers to the primary key D1 in a row in the table D.

In the example shown in FIG. 3A, the addresses of the rows of the client table 220 are sequentially searched for using the reference key “AAA” of the client name 212 in the order table 210, thereby retrieving the row corresponding to the primary key “AAA”. Similarly, a row corresponding to the primary key “444444” in the merchandise table 230 can be retrieved using the foreign key “444444” of the merchandise name 213 in the order table 210. That is, on each of the order table 210, the client table 220, and the merchandise table 230 shown in FIG. 3A, a row in the table can be retrieved by the data structure having consistent data (referred to as “normalized data”) without redundancy by avoiding double columns.

Assuming that an SQL statement of a process request “calculate the total amount of orders on May 10, 2002” has been input through the user interface 110 to the database management system 100 having the data structure of the natural object shown in FIG. 3A as an example of a process request for data manipulations. In this case, the database management system 100 obtains the total amount of order at the process request. FIGS. 4A, 4B, and D are flowcharts of algorithms showing the searching operation at a process request for calculating the total amount of orders in the database management system of the data structure shown in FIG. 3A. FIG. 4C is a table newly generated for the search.

Before performing the processes according to the flowchart, it is necessary to access the database 101 and read the order table and the merchandise table of the natural objects shown in FIG. 3A to the main memory of the database management system 100. When there is such a large volume of data in the order table that they cannot be stored in the available area of the main memory, the suitable number of blocks of data is read depending on an available area, and access is gained to the database 101 several times, thereby reading data in a departmental manner.

The simplest algorithm for calculating the total amount of order can be a method of searching for the row of an orders table 210 dated “2002.5.10”, reading the merchandise name and the number of pieces and storing them in the register, retrieving a corresponding merchandise name from the merchandise table 230 using the merchandise name in the row as a foreign key, reading the unit price of the merchandise having the merchandise name and storing it in the register, multiplying the unit price by the number of pieces, and repeating the routine of computing the amount of orders for the merchandise name.

However, since the above-mentioned algorithm requires access to the two tables, that is, the order table and the merchandise table, each time the amount of orders of the merchandise in one row is calculated, quick data processing cannot be performed because access is frequently made to the database 101 when all blocks forming the order table cannot be read to the main memory. Therefore, another algorithm can be a method of generating a new table corresponding to a total number of retrieved rows to compute the total amount of order by simultaneously retrieving the physical addresses of the rows of the order table dated “2002.5.10” and the total number of rows.

FIG. 4A is a flowchart of generating a new table by retrieving the row dated “2002.5.10” in the order table 210. First, the leading address of the order table 210 is set in the register AD (step S101). The initial value of “0” is also set in the variable m indicating the row of the newly generated table (step S102). Then, the loop processing is repeated from step S103 to step S107 while incrementing the value of m. It is determined at the beginning of the loop processing whether or not the date of the row retrieved using the address of AD is “2002.5.10” (step S103). If the date is “2002.5.10”, then the address of AD is stored in the register R (m) corresponding to the variable m (step S104). Then, 1 is added to the value of m (step S105), and 1 is added to the value of AD to retrieve the next row in the order table (step S106). Then, it is determined whether or not the date of the register AD is NULL, that is, no data (step S107). Unless the date of the register AD is NULL, the search in the order table 210 has not been completed, control is passed to step S103, and the loop processing of retrieving a row dated “2002.5.10” is repeated.

If the date of the register AD is NULL in step S107, that is, if the retrieval of the rows dated “2002.5.10” has been completed, then the value of the variable m is stored in the register M indicating the number of rows of a newly generated table (step S108). Then, a new table having the number (M-1) of rows is generated (step S109), thereby terminating the flowchart.

FIG. 4B is a flowchart of storing a merchandise name and the number of pieces sold in a newly generated table. First, the first row “0” is set in the variable m for designation of the row of a table (step S111). Then, the loop processing from step S112 to step S114 is repeated while incrementing the value of m. At the beginning of the loop processing, the merchandise name on the date “2002.5.10” in the order table 210 is stored in the first column (m, 0) in the row specified by m, and the number of pieces in the row on the date “2002.5.10” in the order table 210 is stored in the next column (m, 1) (step S112). Then, 1 is added to the variable m (step S113), and it is determined whether or not the value of m has reached the value of M (step S114). If the value of m has not reached the value of M, control is passed to step S112, and the loop processing is repeated while storing the merchandise name and the number of pieces. When the value of m has reached the value of M, that is, when all merchandise names and the numbers of pieces on the date “2002.5.10” in the order table 210 are stored in the newly generated table, then the process according to the flowchart terminates.

FIG. 4C shows a table 240 storing all merchandise name and numbers of pieces on the date “2002.5.10” in the order table 210. As shown in FIG. 4C, the merchandise name “111111” and the number of pieces “20” are stored in row 1, the merchandise name “333333” and the number of pieces “5” are stored in row 2, and the merchandise name “444444” and the number of pieces “10” are stored in row 3.

FIG. 4D is a flowchart of computing the total amount of orders on the date “2002.5.10” in the order table 210. First, the register K for storing the total amount of orders is cleared to zero (step S121), and the variable m for designation of the row in the table 240 is set to “0” in row 1 (step S122). Then, while incrementing the value of m, the loop processing from step S123 to step S128 is repeated. At the beginning of the loop processing, the variable n for retrieval of the row in the merchandise table 230 shown in FIG. 3 is set to “0” indicating first row (step S123). Then, it is determined whether or not the merchandise name in the column (m, 0) in the row in the table 240 specified by m matches the merchandise name in the column (n, 0) in the row in the merchandise table 230 searched using the variable n (step S124). If the merchandise names do not match each other, then 1 is added to n, and the next row in the merchandise table 230 is searched (step S125), and it is determined in step S124 whether or not the merchandise names match each other.

If the merchandise names match each other, then the number of pieces of the column (m, 1) in the table 240 is multiplied by the unit price in the column (n, 1) in the merchandise table 230, and the multiplication result is stored in the register K (step S126). Then, 1 is added to m (step S128). If the value of m has not reached the value of M, then control is passed to step S123, and the loop processing is repeated while storing the multiplication result in the register K. If the value of m has reached the value of M, then the value of the register K is output to the user interface (step S129), thereby terminating the flowchart.

Another example of a process request for data manipulations is inputting an SQL statement for a process request to “list all client names, addresses, and staff names in the orders placed on 2002.5.10” from the user interface 110 to the database management system. In this case, the database management system 100 displays the list. First, according to the flowchart shown in FIG. 4A, a row dated 2002.5.10 is retrieved in the order table 210, and a new table having the number of retrieved rows is generated. Then, the client name of the row having the date 2002.5.10 in the order table is stored in the newly generated table.

FIG. 5A is a flowchart of storing client names. First, the variable m for designation of the row of the newly generated table is set to 0 indicating first row (step S201). Then, the loop processing in steps S202 to S204 is repeated with the value of m incremented. At the beginning of the loop processing, the client name of the order table 210 is stored in the row specified by m (step S202). Then, 1 is added to m, and the next row is specified (step S203). It is determined whether or not the value of m has reached the value of M (step S204). If the value of m has not reached the value of M, control is passed to step S202, and the loop processing is repeated with the client name of the order table 210 stored. When the value of m reaches the value of M, the flowchart terminates.

FIG. 5B is a table 250 storing all client names on the date of 2002.5.10. As shown in FIG. 5B, the client name “BBB” is stored in row 1, the client name “EEE” is stored in row 2, and the client name “CCC” is stored in row 3.

FIG. 5C is a flowchart for generation of a list by retrieving the address of the client name and the staff name. First, the variable L for designation of the row of a generated list is set to 0 indicating the first row (step S211). The variable m for designation of the row of the table 250 shown in FIG. 5B is set to 0 indicating the first row (step S212). Then, the loop processing from steps S213 through S229 is repeated with the value of m incremented.

At the beginning of the loop processing, the variable n for retrieval of the row of the client table 220 shown in FIG. 3 is set to 0 indicating the first row (step S213). Then, it is determined whether or not the client name of the column (m) of the row in the table 250 shown in FIG. 5B designated by the variable m matches the client name of the column (n, 0) of the row in the client table 220 shown in FIG. 3 designated by the variable n (step S214). If they do not match, then 1 is added to the value of n, the next row in the client table 220 is specified (step S215), control is passed to step S214, and it is determined whether or not the client name of the column (m) matches the client name of the column (n, 0).

If they match, then the client name of the column (n, 0) of the row in the client table 220 is stored in the area L (0) of the generated list, the address of the column (n, 1) of the row in the client table 220 is stored in the area L (1), and the staff name of the column (n, 2) of the row in the client table 220 is stored in the area L (2) (step S216).

Then, 1 is added to the value of L (step S227), and 1 is added to the value of m (step S228). Then, it is determined whether or not the value of m has reached the value of M (step S229). That is, it is determined whether or not the value has reached a value larger than the trailing row in the table 250 shown in FIG. 5B. If the value of m has not reached the value of M, then control is passed to step S213, and the loop processing is repeated with the client name matching the client name in the table 250 retrieved from the client table 220. If the value of m has reached the value of M, then the generated list is output to the user interface (step S230), thereby terminating the flowchart. FIG. 5D is a list of all client names, addresses, and staff names involved in the orders dated 2002.5.10.

The above-mentioned algorithm is very simple and rudimentary, and a more efficient algorithm can be suggested. Since there are various process requests from the practical user interface 110, it is obvious that the algorithms corresponding to the process requests are considerably complicated. The efficiency of each algorithm largely depends on the ability and technique of each developer.

Thus, in the database management system 100, various tables stored in the database 101 are read to main memory at the respective process requests from the user interface 110, the primary key in a table of an entity is retrieved based on the foreign key of the row in a table of another entity, and the data searching process is frequently performed by referring to the row of the retrieved primary key. Furthermore, some new tables are temporarily generated at various process requests.

The larger the organization of an enterprise which installs a database management system, the larger the amount of data stored in a database and in the temporarily generated table. Therefore, for various process requests from the user interface 110, the algorithm of generating a new table is not to be as simple as shown by the simple flowchart in FIG. 4A, but requires advanced program developing technology. Additionally, to quickly perform the data searching process performed on a large volume of data, various data search algorithms such as the binary search method, the quick sort and search method, the hash search method, the B tree search method, etc. are used.

On the other hand, the database management system largely depends on hardware. For example, the speed of database system CPUs 20 years ago was about 1 MHz with a main memory capacity of about 1 MB. In this case, the time required to fetch a code, decode a code, access data in main memory, perform an AND operation, etc. was about 1 μS. For those computers, fast performance was achieved by the reduction of the total number of process steps by the CPU, and the above-mentioned various data search algorithms were effective.

On the other hand, the speed of CPUs in current database systems is several GHz or more, and the capacity of the main memory is several GB or more. In such a computer, the time required to fetch a code, decode a code, perform an AND operation, etc. is shortened to about 1 ns. However, the time required to access data in the main memory has been shortened to only about 100 ns. As a result, it is difficult to speed up the performance in the entire system only by using the above-mentioned various data search algorithms to reduce the total number of process steps in the process performed by the CPU.

Since the processing of such as a prefetching process of reading an instruction by the CPU in advance has become more and more complicated, it is practically very difficult to grasp the actual operations in each step of the CPU in real time. The term “practically” refers to the necessity of developing an analytic program including a large number of process steps to grasp the per second operations of the CPU. Therefore, a tuning operation such as generating a table with data made to be redundant in the step of system design, incorporating a program for appropriately generating a new table, etc. is performed. That is, a trial-and-error tuning operation is required to design the optimum system for operating a relational database based on the hardware environment including the performance of the CPU, the capacity of a hard disk and main memory, etc.

Furthermore, since a hard disk for storing a natural object as a permanent object to be permanently stored as long as the operation of the system continues, and main memory for storing a natural object as a temporary object to be temporarily stored during the operation of the CPU require a large enough capacity to store a large volume of necessary data recently processed, the entire cost of generating a system is necessarily high.

Additionally, since there are various process requests from user interfaces, and a large volume of data to be processed, a program for generating a new table is not as simple as those shown in the flowcharts in FIGS. 4A, 4B and 4D, and 5A and 5C. Therefore, the development of a program of generating a new table largely depends on the ability and technique of each developer, and it is not wrong to state that the technology used in developing a program determines the performance of a resultant system. Therefore, when a natural object is added, deleted, and changed after a database management system is installed, the table storing the original data is changed, thereby requiring a change in the program. However, since it is very difficult to change the program by an engineer other than the one who developed the program, the universality and the inheritance of the system are lost. Thus, there is the problem of scanty-growth in response to change of future real world.

As described above, the above-mentioned conventional database management system is not responsive to a user request in view of a speeding up, an increasing cost with a larger database capacity, the growth of a system, etc.

### SUMMARY OF THE INVENTION

The present invention aims at providing a scalable database management system capable of performing a high-speed data process, and storing data using a very small storage capacity, a method for generating a data structure in the database management system, and a storage medium therefor.

The database management system according to the present invention includes an object conversion unit and a database, and provides a service to an external unit by performing a process corresponding to a request relating to a natural object recognizable in the real world when a request for data manipulations to add, delete, update, etc. data on the database is received from an external unit.

The database management system holds data as a permanent object during the period in which the system is utilized in either an operation mode in which a service is offered to an external unit, or in an inoperable mode in which a service is stopped.

A permanent object comprises a table group of a hierarchical structure formed by object IDs converted from a natural object by the object conversion unit. In the table group of the hierarchical structure, an object ID as a foreign key in an upper table forming an arbitrary hierarchy with a lower table functions as a pointer directly and uniquely designating a target row in the lower table without searching, and an object ID indicating the row in the lower table directly designates all rows that have foreign keys designating the target row in the upper table without searching, thereby connecting a lower table and another lower table through at least one upper table on a chain and in a bidirectional manner.

Therefore, according to the database management system of the present invention, a plurality of tables of a hierarchical structure form indicate a structure of data connected on a chain in a bidirectional manner. Therefore, when a foreign key of a table refers to a target row in another table, the target row is directly accessed without searching a related table group, thereby performing high-speed data processing.

Since a high-speed process can be performed in response to various data manipulation requests from a user interface, the conventional tuning operation such as generating a table with data made to be redundant in the step of system design, generating a new table by retrieval and aggregate before a manipulation request, etc. is not required to speed up the process. Therefore, extra program development or data areas are not required. As a result, personnel resources and a long development period for the development of programs are not needed, thereby reducing the cost of the system and shortening the system development period.

Furthermore, since there is no need to perform the tuning operation which largely depends on the ability and technique of each engineer, the universality and the inheritance of the system can be maintained. As a result, a hi-growth database management system capable of flexibly responding to the transition of the real world in the future.

Additionally, the object conversion unit of the database management system according to the present invention converts each of the plurality of natural objects and the plurality of object IDs of consecutive integers in a unique relationship and in a bidirectional manner.

Since a natural object of a large volume of data is converted into an object ID of an integer of a very small volume of data, the requirements for the database comprising external storage media such as a hard disk, etc. can be smaller. As a result, the cost of a system including backup and maintenance costs can be considerably reduced. Since an object ID of a very small volume of data probably resides in the main memory, the access frequency to an external storage medium such as a hard disk, etc. becomes very low, thereby performing high-speed data processing.

In the method of generating a data structure according to the present invention, when a table of a hierarchical structure formed by object IDs converted from a natural object is stored in a database as a permanent object for storage of data during the period in which the system is utilized in either an operational mode in which a service is offered to an external unit, or in an inoperable mode in which a service is stopped, an object ID as a foreign key in an upper table forming an arbitrary hierarchy with a lower table functions as a pointer directly and uniquely designating a target row in the lower table without searching, and an object ID indicating the row in the lower table directly designates all rows that have foreign keys designating the target row in the upper table, thereby connecting a lower table and another lower table through at least one upper table on a chain and in a bidirectional manner.

Furthermore, in the method of generating a data structure according to the present invention, each of the plurality of natural objects and each of the plurality of object IDs formed by consecutive integers are converted in a unique relationship and a bidirectional manner.

In the storage medium according to the present invention, a table of a hierarchical structure is stored as a permanent object for holding of data during the period in which the system is utilized in either an operational mode in which a service is offered to an external unit, or in an inoperable mode in which a service is stopped. In the stored table of a hierarchical structure, an object ID as a foreign key in an upper table forming an arbitrary hierarchy with a lower table functions as a pointer directly and uniquely designating a target row in the lower table without searching it, and an object ID indicating the row in the lower table directly designates all rows that have foreign keys designating that target row in the upper table.

The storage medium according to the present invention stores a plurality of object IDs formed by consecutive integers obtained by converting a plurality of natural objects in a unique relationship.

### BRIEF DESCRIPTION OF THE DRAWINGS

FIG. 1 shows the outline of the configuration of a common database system;

FIG. 2 shows an example of a entity relationship model in a relational database of a sales company of a common scale;

FIG. 3A shows the data structure based on the entity relationship model shown in FIG. 2;

FIG. 3B shows the relationship between a primary key and a foreign key, and the row and the column of a table;

FIGS. 4A, 4B, and 4D shows the operations performed at a process request for a total amount of orders in a relational database of the data structure shown in FIG. 3;

FIG. 4C is a table newly generated at a process request for a total amount of orders;

FIGS. 5A and 5C are flowcharts of the searching operation at a process request for a display of a list in the relational database of the data structure shown in FIG. 3;

FIG. 5B is a table newly generated as a result of process request for a display of a list;

FIG. 5D shows the contents of a list output to the user interface as a result of a process request;

FIG. 6 shows the outline of the configuration of the database management system based on the relational database according to the first embodiment of the present invention;

FIG. 7 shows an example of an internal configuration of the object conversion unit according to the first embodiment, and a table stored in the database of the data structure of an object ID;

FIGS. 8A through 8J show the correspondence between a natural object and an object ID bidirectionally converted by each object converter;

FIG. 9 is a flowchart of the data manipulations of the database management system at a process request from a user interface according to a first embodiment of the present invention;

FIG. 10 shows the relationship between a foreign key of a table and a composite object ID of a table referred to by the foreign key;

FIG. 11 shows the state of obtaining a physical address of a target row in a table B to be referred to from the value n of the foreign key in an arbitrary table A according to the first embodiment of the present invention;

FIG. 12 is a flowchart of the data processing corresponding to a process request for a total amount of orders according to the first embodiment of the present invention;

FIG. 13 shows the concept of the process of obtaining a total amount of orders based in a table of a database according to the first embodiment of the present invention;

FIG. 14A shows the concept of the flow of the process of listing staff names and their organizations based in a table of a database according to the first embodiment of the present invention;

FIG. 14B shows a table in which the direction of rows and columns are exchanged;

FIG. 15 shows the relationship in referring to a table using a foreign key of another table according to the first embodiment of the present invention, and the reversed reference index to the reference;

FIG. 16 is a flowchart of generating an reversed reference index according to the first embodiment of the present invention;

FIG. 17 shows a flow of the process of generating an reversed reference index according to the first embodiment of the present invention;

FIG. 18A shows the concept of the state in which a lower table and an upper table are bidirectionally connected in an arbitrary hierarchical level according to the first embodiment of the present invention;

FIG. 18B shows the difference between the prior art and the present invention in relation to an entity of a table;

FIG. 19A shows the difference between the prior art and the present invention in temporary object and permanent object;

FIG. 19B shows an example of comprising data when a natural object is converted into an object ID;

FIG. 20A shows the outline of the configuration of the table of a TPC/D benchmark test defined by the Transaction Processing Performance Council;

FIG. 20B shows a result of the TPC/D benchmark test on the relational database with the configuration according to the first embodiment of the present invention;

FIG. 21 shows the data converting method with the object conversion unit according to the second embodiment of the present invention;

FIG. 22 shows the data converting method with the object conversion unit according to the third embodiment of the present invention;

FIG. 23 shows an array after a sorting process according to the fourth embodiment of the present invention;

FIG. 24 shows an image of the array of the B tree index according to the sixth embodiment of the present invention;

FIG. 25 shows an object array of the B tree index storing natural objects in the order of storing, an image of the B tree, and a tree table;

FIG. 26 is a flowchart of the process of generating a tree table shown in FIG. 25 according to the sixth embodiment of the present invention;

FIG. 27 is a flowchart of the process of converting a natural object into an object ID according to the sixth embodiment of the present invention;

FIG. 28 shows an array of a plurality of B tree indexes according to the seventh embodiment of the present invention;

FIG. 29 shows the concept of a method for sorting data in a hash search method for natural objects as a unique group according to the eighth embodiment of the present invention;

FIG. 30 shows the configuration of the hardware of the computer system for realizing the database management system according to each embodiment of the present invention; and

FIG. 31 shows the configuration of downloading a program and data to a computer system from an external information processing device through a network.

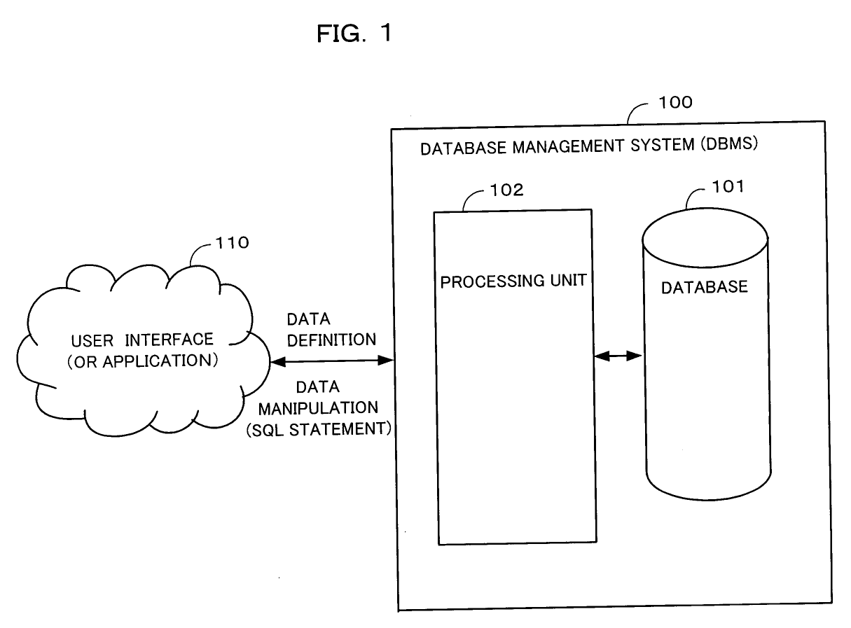

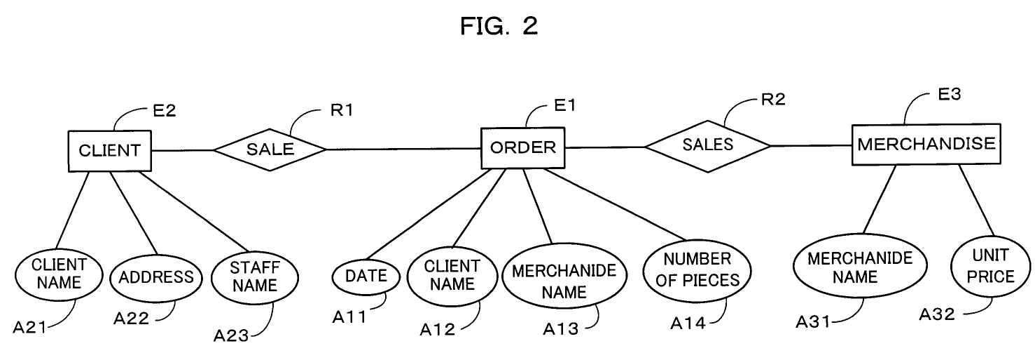

### DESCRIPTION OF THE PREFERRED EMBODIMENTS

The embodiments of the present invention are described below by referring to the attached drawings. In the field of database technology, it is not uncommon for different terms to be used for the same concept, and for similar terms to be used for different concepts. Therefore, terms are to be defined in advance to help understand the embodiments. However, the most important thing is not the term itself, but a substance represented by the term. Therefore, the following definition does not narrow the scope of the present invention nor should it be interpreted as different concepts. The terms used in the “Description of the Related Art” are newly defined below.

(1) Natural Object and Object

In the real world, the information to be manipulated or used by a user, for example, a name, a code, or a quantity, etc. can be defined as a “natural object”. In addition to the natural object, the information for data processing including a pointer, an address, a method, etc. is also defined as an “object” not limited to the above-mentioned name, code, quantity, etc.

(2) Unique

The information indicating the state of a group. Defined to indicate no double elements in the group.

(3) Composite Object

A new object generated by connecting a plurality of objects is defined as a “composite object”. For example, a “legal name” generated by combining two objects “first name” and “family name” is a composite object. Furthermore, a composite object can be combined with another one or more composite objects to generate a new composite object. For example, a composite object “legal name”, an object “birth day”, and an object “address” can be combined to be a new composite object “subscriber”. Additionally, a row in a relational database can be defined as a composite object comprising a plurality of columns forming the row.

A composite object is included in objects. Therefore, in the following explanation, composite objects are not distinguished from objects, and can be referred to also as “objects”.

(4) Object ID

A “value consecutively assigned at equal intervals” corresponding one to one to each natural object defined as (1) above is defined as an “object ID”. A “value consecutively assigned at equal intervals” is a value starting with “p” at equal intervals of “q”, for example, “0, 1, 2, 3, . . . ”, “1, 2, 3, 4, . . . ”, or “0, 0.1, 0.2, 0.3, . . . ”, etc.

In the field of object-oriented databases, a unit of integrally managing programs (methods) and data (property) is referred to as an object, and what is specified to call a specific object is referred to as an object ID. However, they are different from the object ID defined here and the object defined in (1) above.

(5) Composite Object ID

In a broad sense, what is associated one to one to each of the composite objects defined in (3) above is referred to as a “composite object ID”. In a narrow sense, a pointer for direct designation to each row in a table in a relational database is referred to as a “composite object ID”. For example, in an arbitrary table, each row is assigned a composite object ID continuously at equal intervals. For example, the first row is assigned 0, the second row is assigned 1, the third row is assigned 2, . . . .

(6) Permanent Object

The database management system provides a service to an external unit by performing a process corresponding to a data manipulations request when a data manipulations request to add, delete, update, etc. data on a database is externally received in relation to the natural object recognizable in the real world. However, an object holding data during the period in which the system is utilized in either an operation mode in which a service is offered to an external unit, or in an inoperable mode in which a service is stopped is defined as a “permanent object”. Therefore, a permanent object is stored in non-volatile memory, for example, a hard disk, etc. A permanent object can also be referred to as a “data structure” for its structure.

(7) Temporary Object

An object held in an operation mode in which a service is offered from a system to a user interface, etc. is defined as a “temporary object”. Normally, an object generated before starting a target object manipulation and disposed of before completing the manipulation is defined as a temporary object. For example, a temporarily generated object obtained by sorting tables forming a target object for aggregation by field is a temporary object. Therefore, normally, a temporary object is stored in the main memory, but can also be stored in a hard disk or other non-volatile memory.

The present invention is described below in detail.

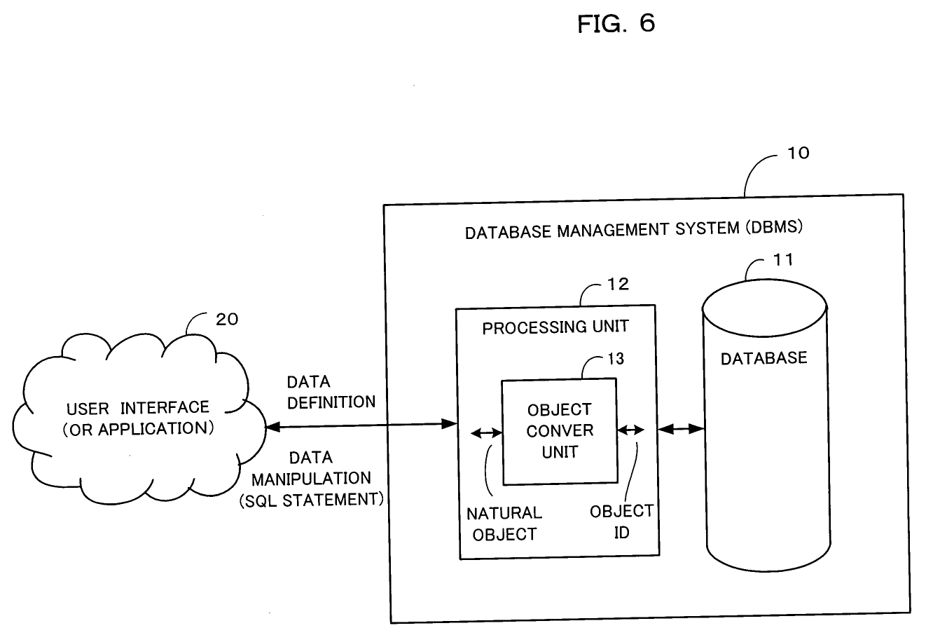

FIG. 6 shows the outline of the configuration of the relational database according to the first embodiment of the present invention. In FIG. 6, a database management system 10 comprises a database 11 and a processing unit 12, and performs data manipulations on the database 11 at a request to add, delete, and update data in a database language such as the SQL from a user interface or a plurality of applications (hereinafter referred to as a user interface 20). An object conversion unit 13 is provided for the processing unit 12 in the database management system 10. The data structure of the database 11 is not the conventional data structure consisting of natural objects recognizable in the conventional target real world, but a data structure of object IDs converted by the object conversion unit 13.

The first feature of the present invention is that the object IDs are represented by integers equal to or larger than 0, that is, the numbers arranged at equal intervals. That is, they are represented by the integers of 0, 1, 2, 3, . . . . Otherwise, they can be consecutive values other than integers. For example, they can be represented by the numbers at intervals of 0.1, that is, 0, 0.1, 0.2, 0.3, . . . . Furthermore, they can be represented by the numbers at intervals of 10, that is, 0, 10, 20, 30, . . . . Furthermore, the leading 0 can be removed. In this embodiment, the object IDs of the simplest data structure represented by 0, 1, 2, 3, . . . are used.

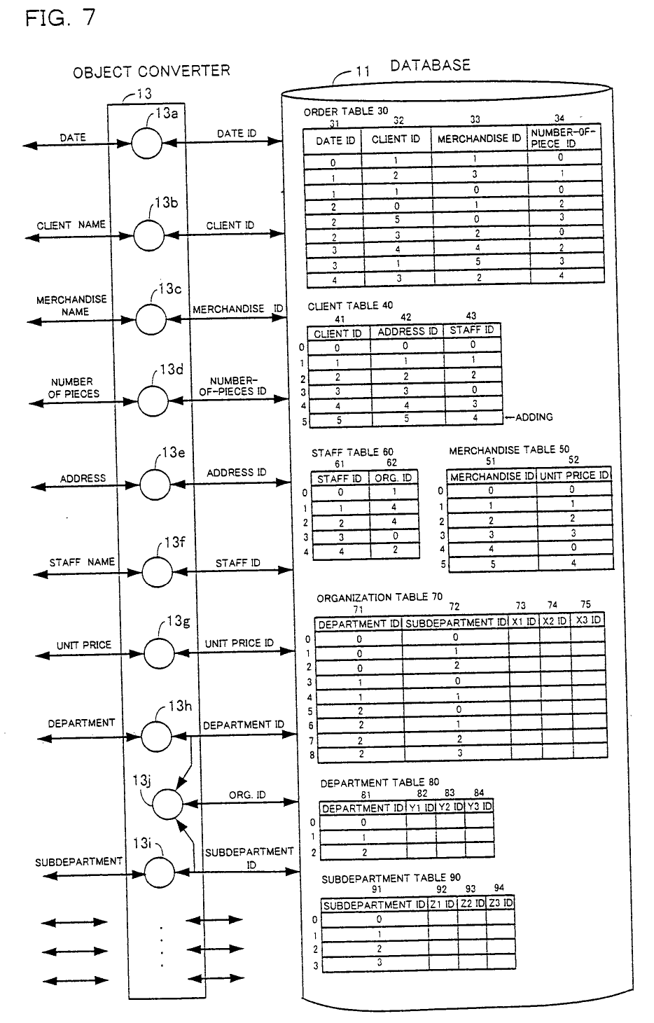

FIG. 7 shows examples of an internal configuration of the object conversion unit 13, and a table stored in the database 11 in the data structure of object IDs. The object conversion unit 13 comprises a plurality of object converters 13a, 13b, . . . , 13h, 13i, . . . corresponding to a natural objects to be converted into object IDs which are a client name, a merchandise name, a number of pieces, an address, a staff name, a unit price, a department and a subdepartment and an organization. That is, each of the object converters 13a, 13b, . . . , 13h, 13i, . . . is an object converter for bidirectional conversion, converts the date, the client name, . . . , the department, the subdepartment, . . . which are various types of natural objects input with a storage request from the user interface 20 into numbers which are object IDs, stores the conversion result in the database 11, converts at a reference request from the user interface 20 the numbers which are object IDs into various natural objects, that is, the date, the client name, . . . , the department, the subdepartment, . . . , and outputs the result to the user interface 20. That is, each object converter is a bidirectional converter exclusive for each type of natural object.

In the object conversion unit 13, the object converter 13j does not perform bidirectional conversion between a natural object and an object ID, but performs bidirectional conversion between the department and subdepartment object IDs and the organization object ID, and is referred to as a composite object converter. The department object converter 13h and the subdepartment object converter 13i are positioned higher than the composite object converter 13j. Thus, a plurality of object converters can form a hierarchical structure.

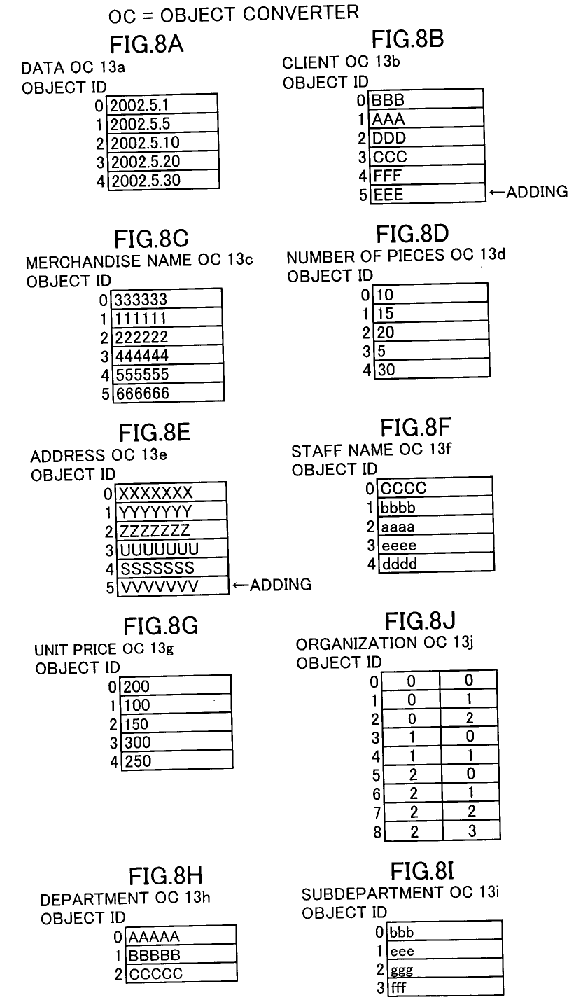

FIGS. 8A through 8J show the correspondence between the natural objects bidirectionally converted by each of the object converters 13a, 13b, . . . , 13h, 13i, 13j, . . . and the object ID. Each figure shows a natural object on the right of each object converter, and an object ID on the left. As clearly shown in the figures, the corresponding natural object and object ID indicates a unique relationship. For example, In the bidirectional conversion dated as shown in FIG. 8A, the natural object “2002.5.1” uniquely corresponds to the object ID “0”, and the natural object “2002.5.5” uniquely corresponds to the object ID “1”.

In FIGS. 6 and 7, each of the object converters 13a, 13b, . . . , 13h, 13i, 13j (FIGS. 8A through 8I) is designed as a permanent object in the processing unit 12. However, each object converter can be stored as a permanent object in the database 11.

Thus, the object ID converted from a natural object by each of the object converters 13a, 13b, . . . , 13h, 13i, 13j, . . . is stored as a table of a hierarchical structure in the database 11 as shown in FIG. 7. That is, the database 11 stores a order table 30, a client table 40, a merchandise table 50, a staff table 60, an organization table 70, a department table 80, and a subdepartment table 90. In each table, each row is assigned integers equal to or larger than 0 represented by “0, 1, 2, 3, . . . ”. The integers assigned to the rows of each table are referred to as composite object IDs. Therefore, the row of each table is uniquely designated by the composite object ID.

As shown in FIG. 7, each row of the order table 30 comprises a plurality of columns including a date ID 31, a client ID 32, a merchandise ID 33, and a number-of-piece ID 34. In the order table 30, the client ID forms a foreign key referring to the client table 40, the merchandise ID forms a foreign key referring to the merchandise table 50. Each row of the client table 40 comprises a plurality of columns including a client ID 41, an address ID 42, and a staff ID 43. In the client table 40, the client ID forms a primary key uniquely designating the row of the table, and the staff name ID forms a foreign key referring to the staff table 60. The row of the merchandise table 50 comprises two columns of a merchandise ID 51 and a unit price ID 52. In the merchandise table 50, the merchandise ID forms a primary key uniquely designating the row of the table. The row of the staff table 60 comprises two columns of a staff ID 61 and an organization ID 62. In the staff table 60, the staff name ID forms a primary key uniquely designating the row of the table, and the organization ID forms a foreign key referring to the organization table 70. Each row of the organization table 70 comprises a plurality of columns comprising a department ID 71, a subdepartment ID 72, other IDs 73, etc. In the organization table 70, the department ID forms a foreign key referring to the department table 80, and the subdepartment ID forms a foreign key referring to the subdepartment table 90. However, in the organization table 70, a single column does not form a primary key, but a composite key which is a combination of a department ID and a subdepartment ID forms a primary key uniquely designating the row of the table. Each row of the department table 80 comprises a plurality of columns including a department ID 81, other IDs 82, etc. In the department table 80, the department ID forms a primary key uniquely designating the row of the table. Each row of the subdepartment table 90 is configured by a plurality of columns including a subdepartment ID 91, other IDs 92, etc. In the subdepartment table 90, the subdepartment ID forms a primary key uniquely designating the row of the table. In the tables other than the order table 30, the consecutive integers assigned to each row and equal to or larger than 0 are composite object ID, and a pointer uniquely designating the row. The pointer is described later in detail.

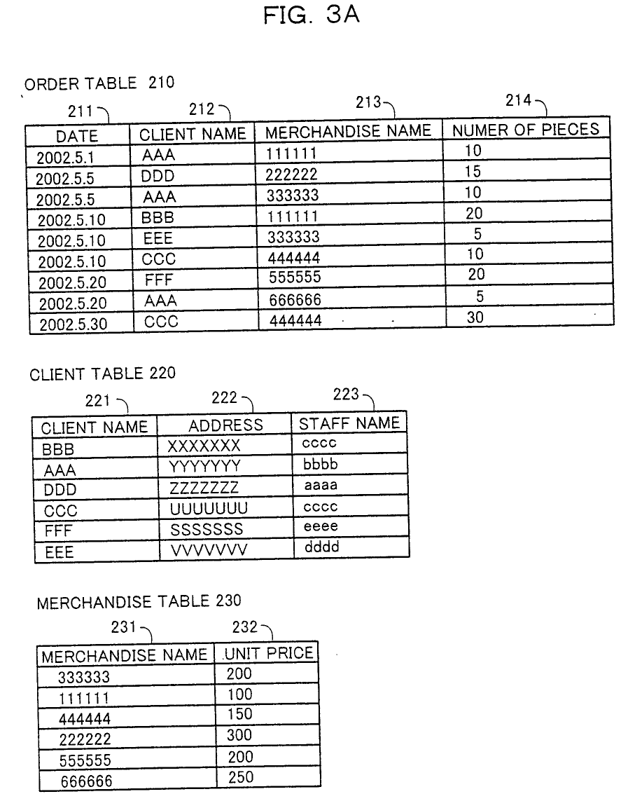

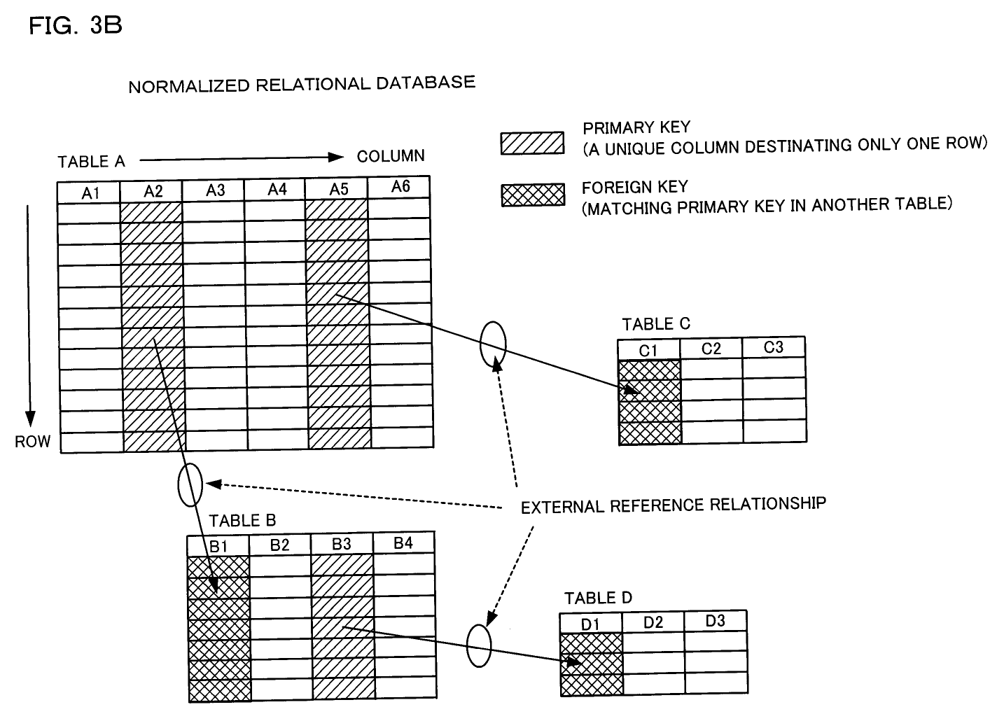

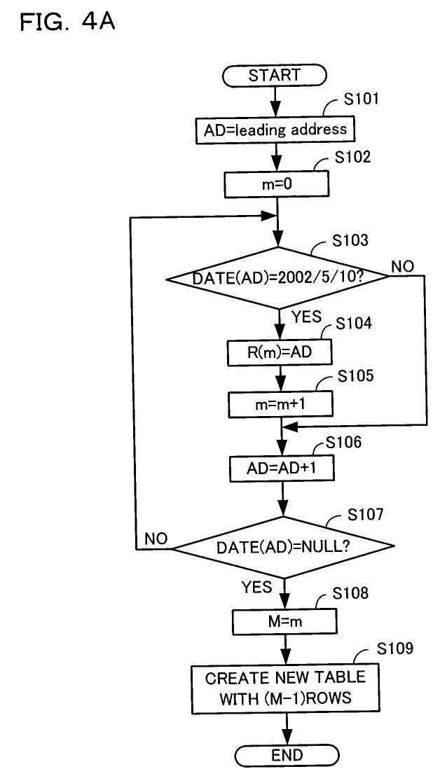

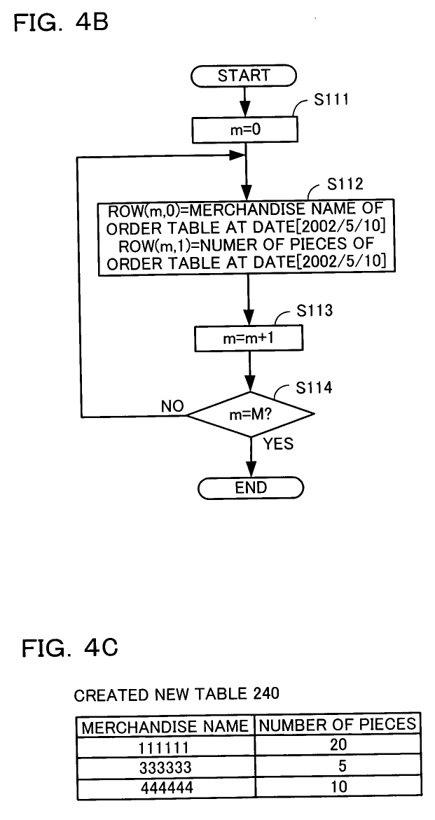

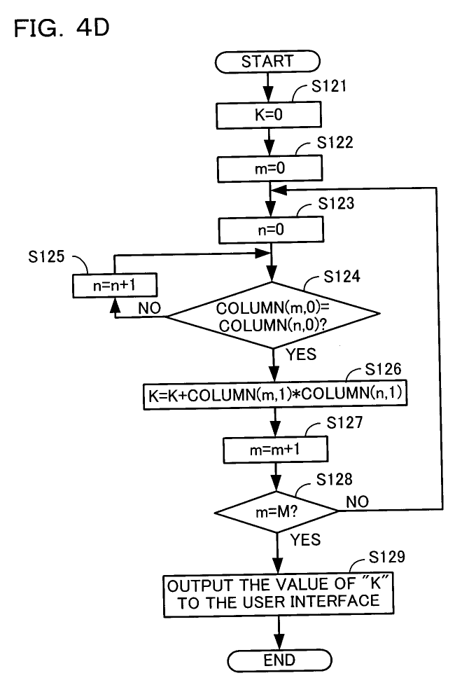

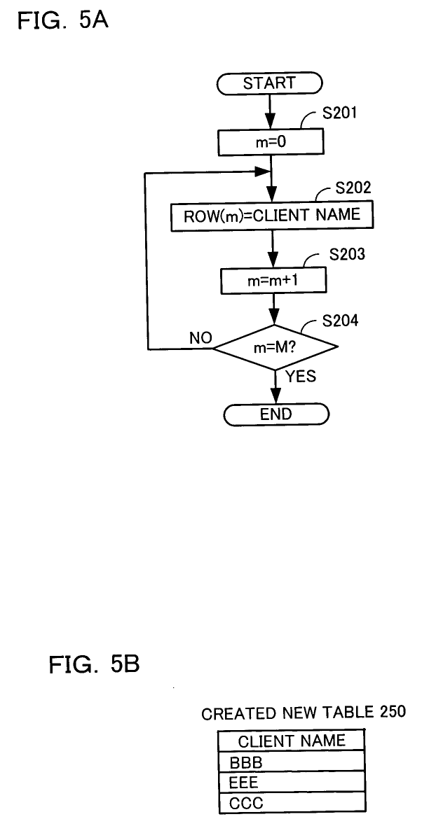

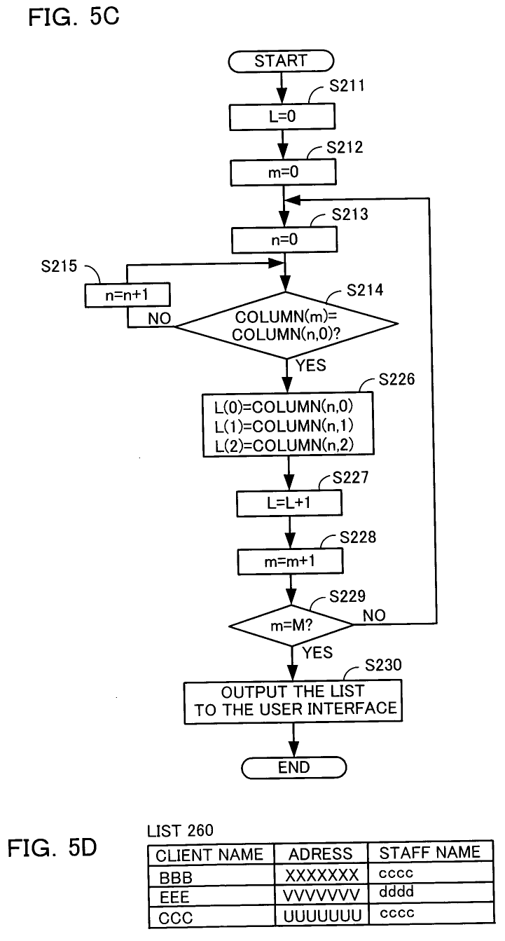

As compared with a conventional table comprising natural objects, a table comprising object IDs only occupies a very small storage area of the database 11. For example, the amount of data the data structure of the object ID in the order table 30 of the database 11 is much smaller than that of the natural object in the conventional order table 210 shown in FIG. 3. Similarly, the amount of data of the client table 40 and the merchandise table 50 of the database 11 is also much smaller than those of the conventional client table 220 and merchandise table 230.

The processing unit 12 shown in FIG. 7 performs data processing corresponding to a process request input in a database language such as SQL from any user interface 20 on an object ID stored in the database 11 to refer to (that is, retrieve), add, delete, and update (that is, delete and add) a row.

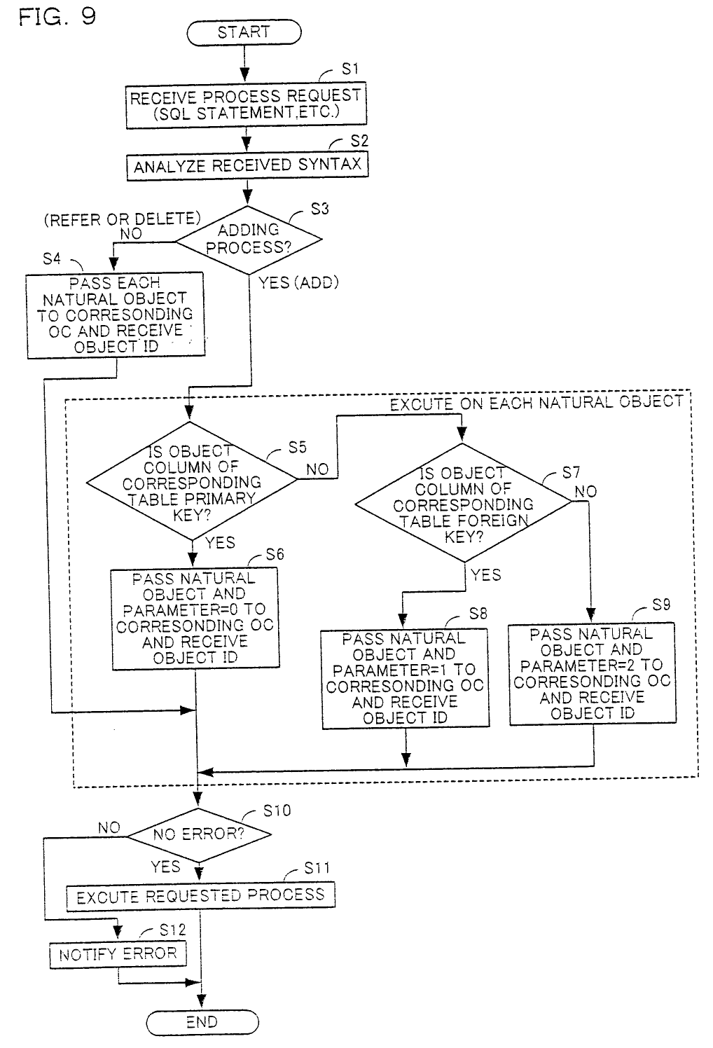

FIG. 9 is a flowchart of data manipulations by the processing unit 12 and the object conversion unit 13 at the process request from any user interface 20. A process request in a database language such as SQL, etc. is received (step S1), and a syntax analyzing process is performed on the database language (step S2). As a result of the syntax analysis, it is determined whether or not the process request refers to a process of adding a row (step S3). If the process request refers to reference or deletion of a row, not addition of a row, then a natural object related to the process request is passed to the corresponding object converter (hereinafter referred to as an OC for short in the flowchart), and a converted object ID is received (step S4). If the process request refers to addition in step S3, the parameter is set to the value of 0, 1, or 2 depending on whether the natural object to be added is a primary key, a foreign key, or any of the others. If it is determined whether or not the column of the corresponding table is a primary key (step S5) and the column refers to the primary key, then the natural object and the parameter of 0 are passed to the object converter, and an object ID which is the conversion output is received (step S6). If the column does not refer to a primary key in step S5, it is determined whether or not the column refers to a foreign key (step S7). If the column refers to a foreign key, then the natural object and the parameter of 1 are passed to the object converter, and an object ID which is the conversion output is received (step S8). If the column does not refer to a foreign key in step S7, that is, the column refers to any key other than the primary key and the foreign key, then a natural object and a parameter of 2 are passed to the object converter, and the object ID which is the conversion output is received (step S9). After receiving an object ID in step S4, S6, S8, or S9, it is determined whether or not there is an error in the process request (step S10). If there is no error, the process request is executed (step S11). If there is an error, the error information is transmitted to the user interface 20 (step S12).

The process request from the user interface 20 refers to addition of a row, some of the processes from step S5 through S9 are repeated for the natural object of each column because a plurality of columns normally form a row.

If a corresponding object converter refers to the value of the parameter of 0 in the process in step S10 in which it is determined whether or not there is an error in the process request, that is, if the object ID corresponding to the natural object to be processed is a primary key, it is determined whether or not the natural object has been stored in the memory. If it has not been stored, then the object ID converted from the natural object is output, and the correspondence between the natural object and the object ID is stored in the memory. If the natural object has been stored, then the primary key cannot be double stored, and error information is output.

If the value of the parameter is 1, that is, if the object ID corresponding to the natural object to be processed is a foreign key, then the object converter determines whether or not the natural object has been stored in the memory. If it has not been stored, then there is no primary key to be referred to by a foreign key, and error information is output. If the natural object has been stored, then the object ID of the primary key to be referred to by the foreign key is output.

If the value of the parameter is 2, that is, if the object ID corresponding to the natural object to be processed is a key other than the primary key and the foreign key, then the object converter determines whether or not the natural object has been stored in the memory. If it has not been stored, then the object ID converted from the natural object is output, and the correspondence between the natural object and the object ID is stored in the memory. If the natural object has been stored, then the object ID corresponding to the natural object is output.

Described below is a practical example of a process request for addition from the user interface 20. When a process request to add a row comprising “a client name EEE, an address VVVVVVV, a staff name dddd” to the client table 40 of the database 11 shown in FIG. 7 is issued, the processing unit 12 transmits the natural object “EEE” and the parameter of 0, the natural object “VVVVVV” and the parameter of 1, and the natural object “dddd” and the parameter of 2 respectively to the client object converter 13b, the address object converter 13e, and the staff name object converter 13f.

As shown in FIG. 8B, the object converter 13b determines that “EEE” has not been stored, and outputs “5” obtained by adding 1 to the current object ID 4 as the object ID corresponding to the “EEE”. Then, it associates “EEE” with “5”, and stores them. As shown in FIG. 8E, the object converter 13e determines that “VVVVVVV” has not been stored, and outputs “5” obtained by adding 1 to the current object ID “4” as the object ID corresponding to “VVVVVVV”. It associates the “VVVVVVV” with “5”, and stores them. As shown in FIG. 8F, the object converter 13f determines that “dddd” has been stored, and outputs the object ID “4” corresponding to “dddd”.

Upon receipt of the object ID from each object converter, the processing unit 12 assigns a new composite object ID “5” in the client table 40 of the database 11, and adds the row comprising the client ID “5”, the address ID “5”, and the staff name ID “4”.

In another example, when the user interface 20 issues a process request to add a new row to the order table 30 of the database 11, the processing unit 12 transmits to each of the date, client, merchandise and number-of-pieces object conversion units 13a, 13b, 13c, and 13d the corresponding natural object and parameter to the row to be added. For example, when a process request to add a row “date “2002.6.1, client name DDD, merchandise 444444, number of pieces 15”, only the date “2002.6.1” has not been stored in the date object conversion unit 13a, but other natural objects have been stored in each of the object converters. Therefore, the date object converter 13a associates the natural object “2002.6.1” with the object ID “5” and stores them in the memory, and outputs the object ID “5” to the processing unit 12. The processing unit 12 receives the object IDs “5”, “2”, “3”, and “1” from each object converter, and adds a new row to the order table 30 of the database 11. As described above, the value of a foreign key of a table can uniquely designate a row of another table using a composite object ID which is a pointer. For example, the client ID “2” of the order table 30 designates the row corresponding to the composite object ID “2” of the client table 40 . The staff name ID “2” of the order table 30 designates the row corresponding to the composite object ID “2” of the staff table 60. The organization ID “4” of the staff table 60 designates the row of the composite object ID “4” of the organization table 70.

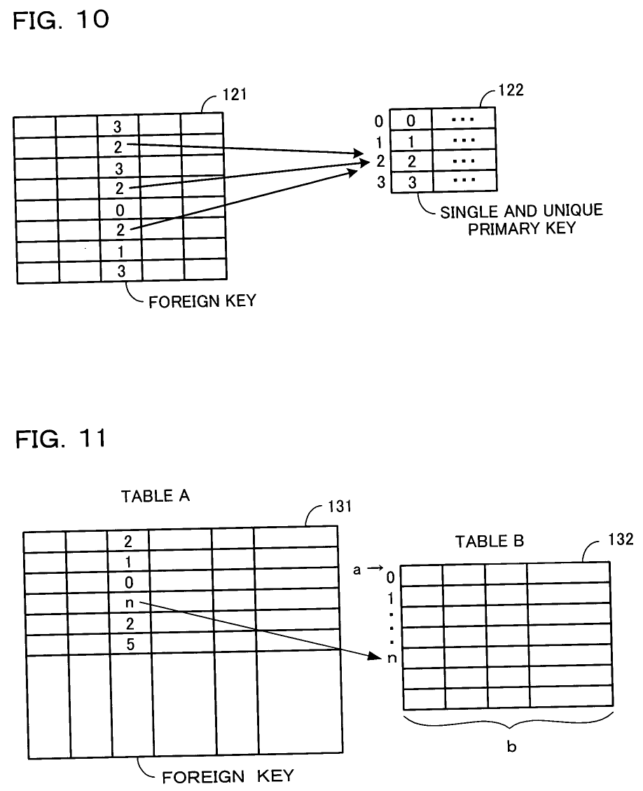

FIG. 10 shows the relationship between a foreign key of a table and a composite object ID of a table referred to by the foreign key. As shown in FIG. 10, when a table 122 referred to by a column of a foreign key of a table 121 has a column which can be solely a primary key, the value of the object ID of the foreign key (for example, “2”) directly corresponds to the value (“2”) of the composite object ID of the referred-to table 122. For example, in the database 11 shown in FIG. 7, the merchandise ID “2” of the order table 30 directly corresponds to the composite object ID “2” of the merchandise table 50. The client ID “1” of the order table 30 directly corresponds to the composite object ID “1” of the client table 40.

Therefore, according to the relationship of (value of foreign key)=(value of composite object ID), the physical address (absolute address) of the row corresponding to the composite object ID of a table can be computed based on the value of the foreign key of another table. FIG. 11 shows the state of obtaining a physical address of a target row in a table B to be referred to from the value of the foreign key in an arbitrary table A. Assuming that the value of the foreign key in the table A is “n”, there is a target row in the position of the value “n” of the composite object ID in the table B. The physical address of the target row is computed by the following equation (1).

physical address=a+b*n (1)

where a indicates the leading address of the table B, and b indicates the byte size of the row in the table B to be referred to.

However, the above-mentioned equation (1) is an equation in which the value of the composite object ID starts with 0 such as “0, 1, 2, 3, . . . ”, etc. at equal intervals of 1.

For example, if the value of the composite object ID starts with 2, the following equation (2) holds.

physical address=a+b*(n−2) (2)

When the equal intervals of the composite object ID are 0.1, the following equation (3) holds.

physical address=a+b*n*10 (3)

Therefore, when the arithmetic progression in which the value of the composite object ID starts with “p”, and the equal intervals are q holds, the following equation (4) is used.

physical address=a+b*(n−p)÷q (4)

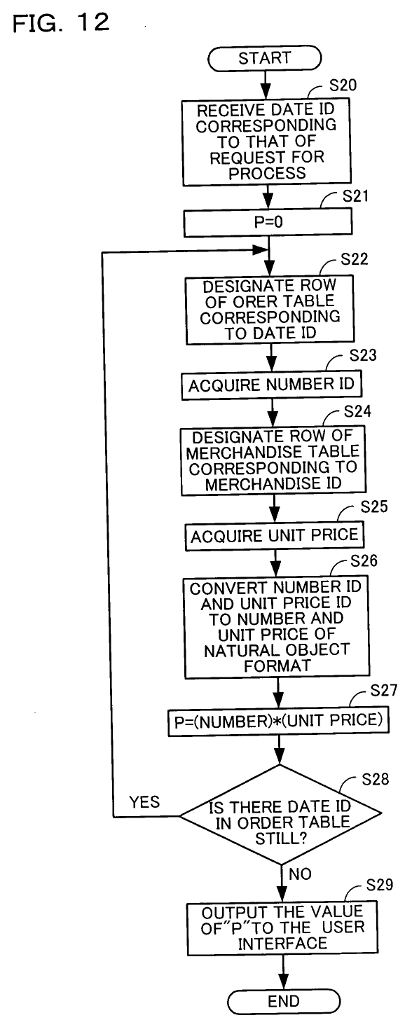

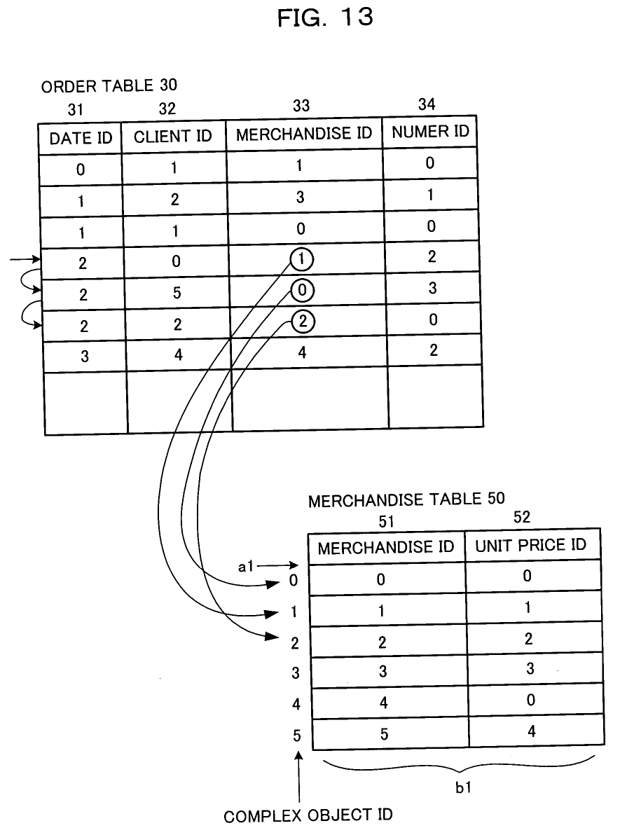

Assume that a user interface 20 inputs a process request in the SQL statement that “obtain a total amount of orders on the date of “2002.5.10″” for example. In this case, the processing unit 12 obtains a total amount of orders in response to the process request. FIG. 12 is a flowchart of the data processing for the process request to obtain the total amount of orders. FIG. 13 shows the concept of the process flow of obtaining the total amount of order according to the table of the database 11.

In FIG. 12, the date ID “2” corresponding to the “date of 2002.5.10” is received from the object conversion unit 13a (step S20). Then, the initial value of the total amount of orders P is set to 0 (step S21). The row of the order table corresponding to the date ID “2” is designated (step S22). That is, in the order table 30 shown in FIG. 13, the fourth row is designated. Then, the number ID of the designated row is obtained (step S23). That is, the number ID “2” is obtained from the row designated in the order table 30 shown in FIG. 13. Then, the row in the merchandise table corresponding to the merchandise ID is designated (step S24). That is, using the merchandise ID “1” which is the foreign key of the order table 30 shown in FIG. 13 as a pointer, the row of the composite object ID “1” is designated in the merchandise table 50. In this case, assuming that the leading address of the merchandise table 50 is a1, and the data length of a row is b1 byte, the physical address of the row of the merchandise table 50 corresponding to the merchandise ID “1” is computed by the following equation based on the equation (1) above.

physical address=a1+b1*1

Then, the unit price ID of the row is obtained (step S25). That is, the unit price ID “1” of the merchandise table 50 shown in FIG. 13 is obtained. Then, the obtained number ID and the unit price ID are converted into the number of pieces and the unit price of the natural object (step S26). That is, the number ID “2” of the order table 30 is transmitted to the object conversion unit 13d for conversion, and the unit price ID of the merchandise table 50 is transmitted to the object conversion unit 13c for conversion. Then, the number of pieces is multiplied by the unit price, and the product is stored in the total amount of orders P (step S27), and it is determined whether or not there is still a row containing the date ID ‘2’ on the order table 30 (step S28). If there is a row containing the date ID ‘2’, then control is passed to step S22, and the loop processing up to step S28 is repeated. If there is no row corresponding to the date ID ‘2’, then the value of the total amount of orders is output to the user interface 20 (step S29). Similarly, the physical address of the row of the corresponding merchandise table is computed by the following equations for other merchandise IDs “0” and “2”.

physical address=a1+b1*0

physical address=a1+b1*2

Thus, using as a pointer the merchandise ID which is the foreign key of the order table, the position of a target row can be directly obtained by an arithmetic operation based on the leading address a1 of the merchandise table, the byte size b1 of the row, and the value of the foreign key. Since there is no need to retrieve a target row in the merchandise table as in the conventional method, access can be gained to a row of a table to be referred to within a very short time.

As another example of a process request in data manipulations, assume that the SQL statement of a process request to “list staff names and its departments and subdepartments relating to the clients who ordered merchandise on the date of 2002.5.10” has been input from a user interface 20. The flowchart of the processing unit 12 in this case is the same as that shown in FIG. 12 in basic operation concept. Therefore, the flowchart is omitted here.

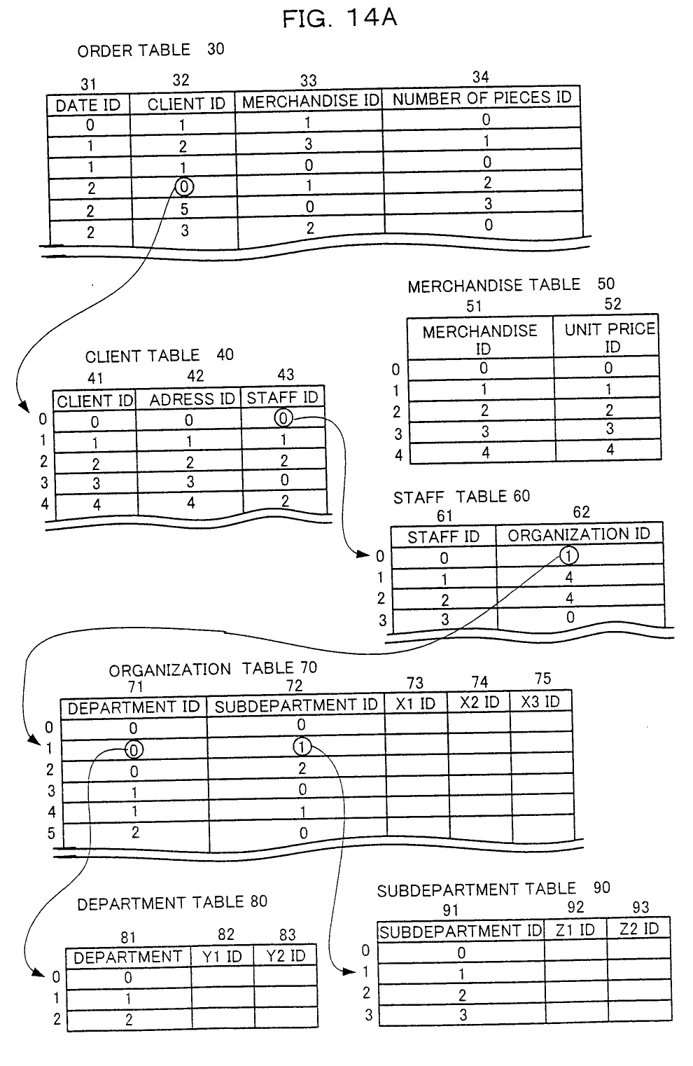

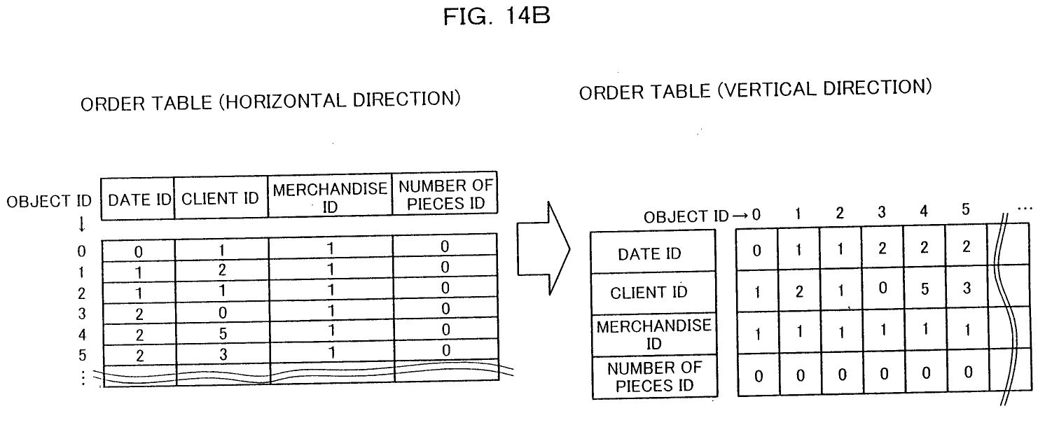

FIG. 14A shows the concept showing the flow of the process in which staff names and their departments and subdepartments are listed according to the table of the database 11. The consecutive integers equal to or larger than 0 assigned to each row of the tables other than the order table 30 are composite objects, and are pointers designating the respective rows. As shown in FIG. 14A, the processing unit 12 designates the row of the order table 30 using as a pointer the date ID “2” which is a foreign key corresponding to the date of “2002.5.10”. Then, the client ID “0” of the designated row is obtained, and the row of the composite object ID “0” in the client table 40 is designated using as a pointer the client ID “0” which is a foreign key. In this case, the physical address of the row of the client table can be computed by the following equation based on the equation (1) above.

physical address=a2+b2*0

where a2 indicates the leading address of the client table 40, and b2 indicates the byte size of the row of the client table 40.

Then, the staff ID “0” of the designated row is obtained, and the row of the composite object ID “0” in the staff table 60 is designated using as a pointer the staff ID “0” which is the foreign key. In this case, the physical address of the row of the staff table 60 can be computed by the following equation based on the equation (1) above.

physical address=a3+b3*0

where a3 indicates the leading address of the staff table 60, and b3 indicates the byte size of the row of the staff table 60.

Then, the row of the composite object ID “1” in the organization table 70 is designated using as a pointer the organization ID “1” which is the foreign key of the row. In this case, the physical address of the row of the organization table 70 can be computed by the following equation based on the equation (1) above.

physical address=a4+b4*1

where a4 indicates the leading address of the organization table 70, and b4 indicates the byte size of the row of the organization table 70.

Then, using as a pointer the department ID “0” and the subdepartment ID “1” which are two foreign keys of the row, the row of the composite object ID “0” in the department table 80 and the row of the composite object ID “1” in the subdepartment table 90 are designated, and the rows are obtained. In this case, the physical addresses of the rows of the department table 80 and the subdepartment table 90 can be computed by the following equation based on the equation (1) above.

physical address of department table=a5+b5*0

where a5 indicates the leading address of the department table 80, and b5 indicates the byte size of the row of the department table 80.

physical address of subdepartment table=a6+b6*1

where a6 indicates the leading address of the subdepartment table 90, and b6 indicates the byte size of the row of the subdepartment table 90.

If there is a next row in the date ID “2” in the order table 30, the row is designated, and, as in the case above, the process of obtaining the client ID, the staff name ID, the department ID, and subdepartment ID is repeated by designating the row of the composite object ID in the other tables using the foreign key as a pointer. When the client ID, the staff name ID, the department ID, and the subdepartment ID are obtained for all rows corresponding to the date ID “2”, the listed data of the staff name and its department and subdepartment relating to the client who placed merchandise on the date of 2002.5.10 is output to the user interface 20.

Thus, the position of the target row in the client table 30 is directly obtained by an arithmetic operation using as a pointer the client ID which is a foreign key in the order table 30, the position of the target row in the staff table 60 is directly obtained by an arithmetic operation using as a pointer the staff ID which is a foreign key in the client table, the position of the target row in the organization table 70 is directly obtained by an arithmetic operation using as a pointer the organization ID which is a foreign key in the staff table 60, the positions of the target rows in the department table 80 and the subdepartment table 90 are directly obtained by arithmetic operations using as pointers the department ID and the subdepartment ID which are foreign keys in the organization table 70. Therefore, since there is no need to retrieve a target row as in the prior art, a row of each table to be referred to can be accessed within a very short time. The leading address a of each table to be referred to and the byte size b of a row are set in a predetermined storage area in advance.

When the listed data and other display data output to the user interface 20 are output (displayed, printed, stored on media, downloaded, transmitted, etc.) in a table form comprising rows and columns, it is not always necessary for the relationship between the rows and the columns to be consistent with the relationship between the rows and the columns in the tables in the database 11. For example, when the contents of an order table 30 are displayed, the rows can be arranged in the horizontal direction on the screen, and the columns can be arranged in the vertical direction on the screen. FIG. 14B shows a table in which the directions of the rows and the columns are exchanged.

As shown in FIG. 14A, among the tables in which a row is designated by a composite object ID, only the organization table 70 does not comprise a primary key by a single column. That is, the primary key comprises a composite key of a department ID and a subdepartment ID. Therefore, a department table 80 and a subdepartment table 90 cannot be referred to directly by a foreign key of the staff table 60. That is, a department table 80 and a subdepartment table 90 are referred to through the organization table 70. The object converter 13j shown in FIG. 7 is provided in generating a table for unique designation of a department table 80 and a subdepartment table 90 as shown in FIG. 8J, and a generated table is stored in the non-volatile memory of the database 11 or the processing unit 12.

In the order table 30, the client ID 32 is a foreign key for reference to a client table 40, and the merchandise ID 33 is a foreign key for reference to a merchandise table 50. That is, according to this embodiment, in the relationship between “many” to “one”, the process of referring to “one” by “many” using a foreign key as a pointer, but there is a case in which the process of referring to “many” by “one” is required. For example, in FIG. 14A, the order table 30 is necessary to be referred to by the merchandise table 50. In this case, if the order table 30 is referred to using the merchandise ID “0” of the merchandise table 50 as a foreign key, then there is external reference to two rows having the value of “0”, and one row cannot be uniquely designated.

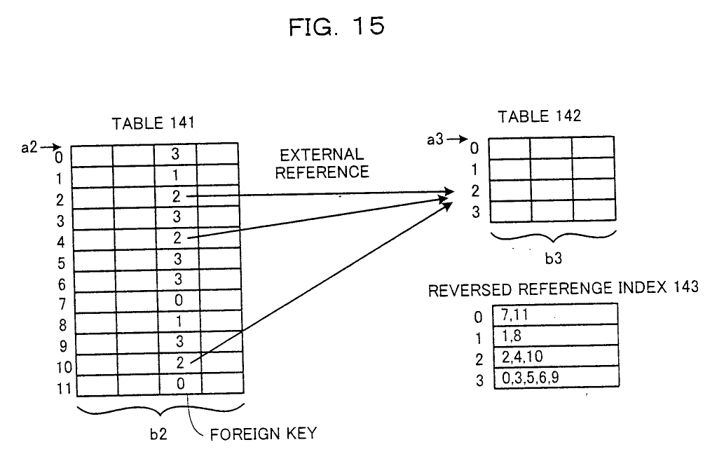

FIG. 15 shows the relationship by reversely referring to a table using a foreign key of another table, and the reversed reference index to the reference. In FIG. 15, using the value of the foreign key of a table 141, the leading address “a3” of a table 142, and the byte size “b3” of a row of the table 142, the row of the composite object ID in the table 142 is referred to by the equation (1) above. For example, the two foreign keys “0” in the row of the composite object IDs “7” and “11” of the table 141 refer to the row of the composite object ID “0” of the table 142. The two foreign keys “1” in the row of the composite object IDs “1” and “8” of the table 141 refer to the row of the composite object ID “1” of the table 142. The three foreign keys “2” in the row of the composite object IDs “2”, “4”, and “10” of the table 141 refer to the row of the composite object ID “2” of the table 142. The five foreign keys “3” in the row of the composite object IDs “0”, “3”, “5”, “6”, and “9” of the table 141 refer to the row of the composite object ID “3” of the table 142. That is, the row of one composite object ID “one” of the table 142 can be referred to by a plurality of foreign keys “many” of the table 141.

On the other hand, using the value of the foreign key of the table 142, the leading address “a2” of the table 141, and the byte size “b2” of a row, the row of the table 141 cannot be reversely referred to by the foreign key of the table 142 based on the equation (1) above. For inverse reference, a reversed reference index 143 shown in FIG. 15 is required. For example, to reversely refer to the row containing the foreign key “2” of the table 141, the foreign keys “2”, “4”, and “10” in the row of the composite object ID “2” of the reversed reference index 143 can refer to the row of the corresponding composite object IDs “2”, “4”, and “10” in the table 141. In this case, using the leading address “a2” of the table 141, the byte size “b2” of the row, and the foreign keys “2”, “4”, and “10” of the table 142, each physical address of the target row (“AD1”, “AD2”, and “AD3”) can be obtained by the following equation based on the equation (1) above.

AD1=a2+b2*2

AD2=a2+b2*4

AD3=a2+b2*10

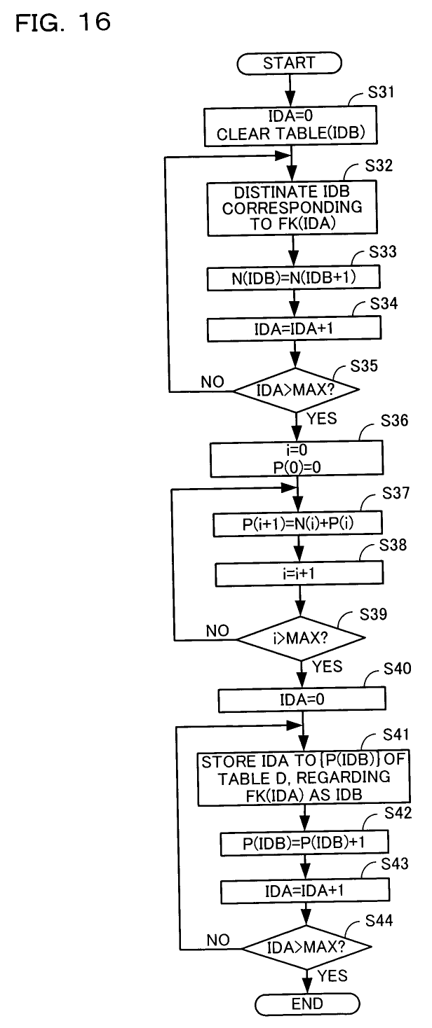

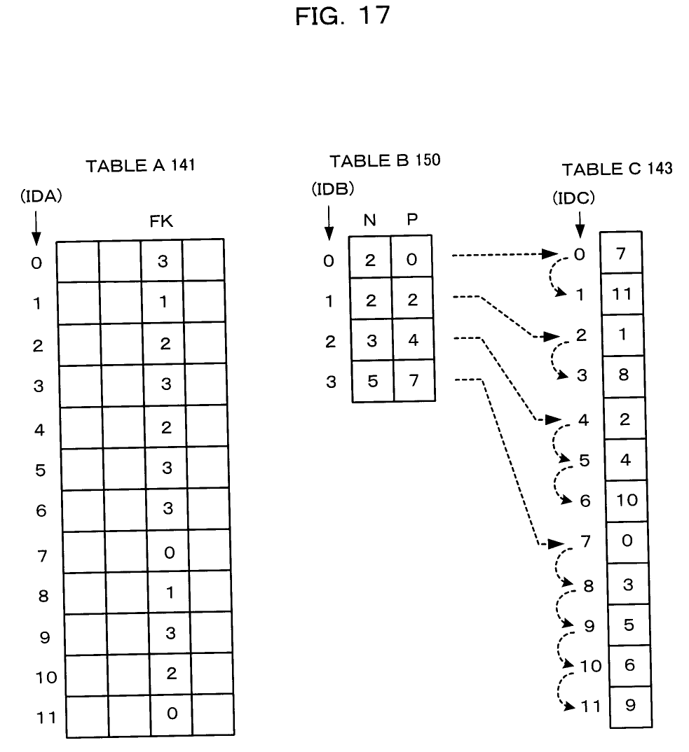

Described below is the process of generating the reversed reference index 143. FIG. 16 is a flowchart for generation of the reversed reference index 143. FIG. 17 shows the flow of the process of generating the reversed reference index 143. In FIG. 17, the table 141 is defined as a table A, the composite object ID is represented by “IDA”, the foreign key is represented by “FK”, the reversed reference index 143 is defined as a table C, the composite object ID is represented by “IDC”, and the value of the reversed reference index is represented by “IDX”. A table 150 is a table for use in generating an reversed reference index, and is defined as table B. Table B contains a counter N storing a count value of the FK of the table A, and a pointer P for reference to the composite object ID of the reversed reference index 143. The value of the P is a pointer to the IDC which is the composite object ID of the table C.

In FIG. 16, the IDA of the table A is set to the initial value of 0, and the table (IDB) is cleared to zero (step S31). Then, the IDB of the table B referred to by the FK, which is the foreign key of the row designated by the IDA, that is FK (IDA), is designated (step S32). Then, the column N of the row of the specified IDB, that is, the N (IDB) is increased by 1 (step S33). Since the IDA=0 at first, the counter N of the IDB=3 corresponding to the FK=3 of the table A is incremented by 1. Since the initial value of N is cleared to zero in step S31, the value of N after the increment by 1 is 1. Then, 1 is added to the value of the IDA (step S34). Then, it is determined whether or not the value of the IDA has become larger than the maximum value (step S35). If it is not larger than the maximum value, then control is passed to step S32, and the loop processing up to step S35 is repeated. That is, the number of pieces of the values of the FK is accumulated to the N of the IDB of the table B corresponding to the value of FK in each IDA of the table A. When the value of the IDA has become larger than the maximum value as a result, the number of the pieces the values of “0”, “1”, “2”, and “3” of the FK in the table A are respectively 2, 2, 3, and 5, the counters N of the IDB of “0”, “1”, “2”, and “3” in table B respectively store “2”, “2”, “3”, and “5” as shown in FIG. 17.

If the value of the IDA becomes larger than the maximum value in step S35, then the variable i for designation of the position of the pointer P is set to 0, and 0 is stored in the P (i=0) (step S36). Therefore, the value of the P “0” of the table B specifies the first row of the table C storing the smallest FK value of “0” of the table A. Then, the value obtained by adding the value of the P(i) to the value of the N(i) is stored in the next pointer P(i+1) (step S37). That is, the first address of the table C storing the next FK value of the table A is specified. Then, 1 is added to the value of i (step S38). Then, it is determined whether or not the value of i has reached the largest value (step S39). If the maximum value has not been reached, control is passed to step S37 and the loop processing up to step S39 is repeated. When the value of i has reached the maximum value as a result, the pointers P of the table B store the first addresses 0, 2, 4, and 7 in the table C respectively storing the FK values of 0, 1, 2, and 3 of the table A as shown in FIG. 17.

If the value of the IDB has reached the maximum value in step S39, then the table A is scanned again. That is, the IDA is set to the initial value of 0 (step S40), and the loop processing from step S41 to step S44 is repeated while incrementing the value of the IDA until the value of the IDA becomes larger than the maximum value. First, the FK (IDA) is set to the value of the IDB, and the pointer P (IDB) of the table C stores the value of the IDA (step S41). For example, if the value of the IDA is 0, then the FK (IDA) is “3” in the table A. Therefore, in the table B, the value of the P (IDB) is 7 when the value of the FK (IDA) equals the value of the IDB. As a result, in the table C, the IDS of the row having the IDC of “7” stores the value of the IDA of “0”. After step S41, 1 is added to the value of the P (IDB) (step S42).

Therefore, when the value of the P (IDB) is 7, the value is incremented into 8. That is, in the table A, the address of the table C storing the value of the IDA of the next row whose FK (IDA) value is 3 is set to 8. After step S42, 1 is added to the value of the IDA (step S43). That is, the next row of the table A is specified. After the increment, it is determined whether or not the value of the IDA has become larger than the maximum value (step S44).

If it is determined that the maximum value is not exceeded, control is passed to step S41, and the loop processing up to step S44 is repeated. If the IDA exceeds the maximum value, that is, when scanning the table A is completed, the values of the IDAs of all rows corresponding to the values of FK of 0, 1, 2, and 3 are stored in the IDX of the table C, thereby terminating the generation of the reversed reference index.

Using as a pointer the foreign key in an arbitrary row in any table, a specific row in another arbitrary table can be directly and freely referred to without considering the address or the index, and without considering the rules of the hierarchical structure of a table by providing the reversed reference index in the database 11.

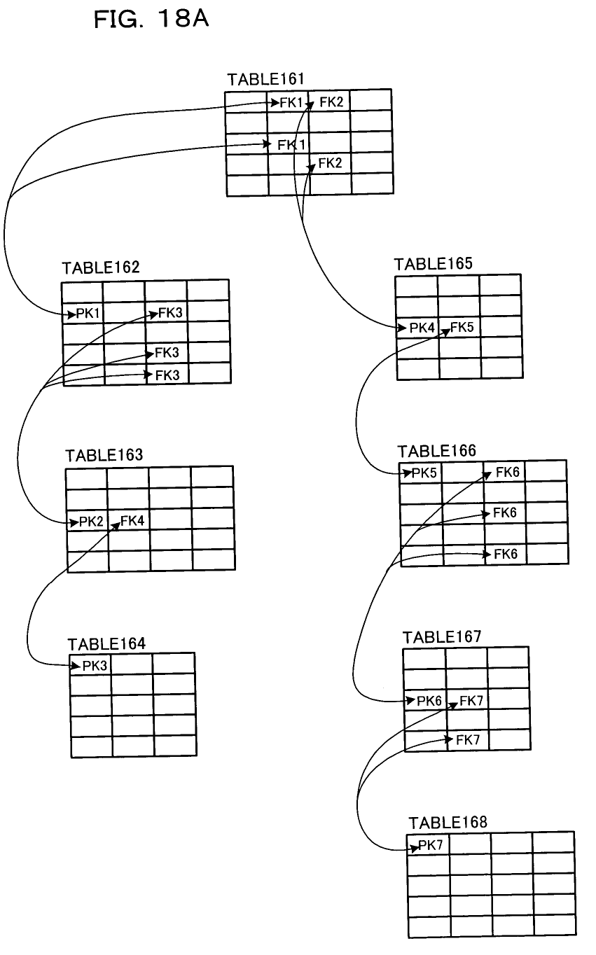

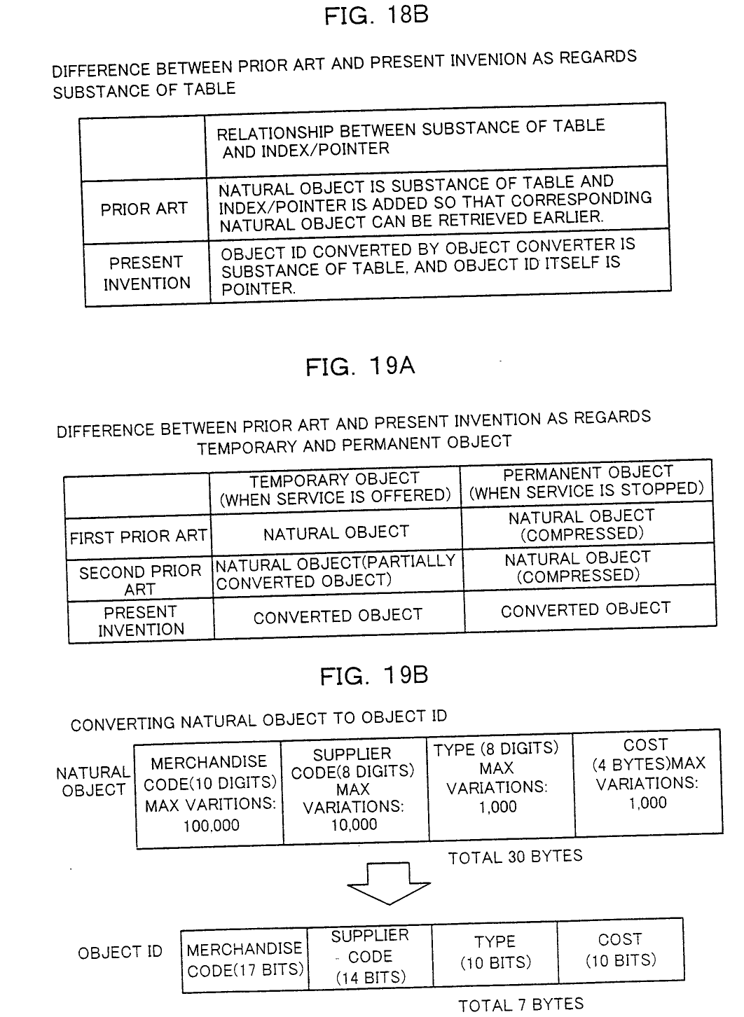

FIG. 18A shows the concept of the state in which a lower table and an upper table are bidirectionally connected in an arbitrary hierarchical level. The highest order table 161 is downward followed by tables 162, 163, and 164 in this order. The highest order table 161 is also followed downward by a tables 165, 166, 167, and 168 in this order.

In FIG. 18A, the table 161 is connected to the row of the primary key PK1 of the lower table 162 using each foreign key FK1 in the two rows as a pointer, and the table 162 is connected to the two rows having the foreign key FK1 of the table 161 by an inverse index of the primary key PK1. The table 162 is connected to the row of the primary key PK2 of the lower table 163 using each foreign key FK3 in the three rows as a pointer, and the table 163 is connected to the three rows having the foreign key FK3 of the table 162 by an inverse index of the primary key PK2. The table 163 is connected to the row of the primary key PK3 of the lower table 164 using the foreign key FK4 in one row as a pointer, and the table 164 is connected to the row having the foreign key FK4 of the table 163 by an inverse index of the primary key PK3.

Similarly, the table 161 is connected to the row of the primary key PK4 of the lower table 165 using each foreign key FK2 in the two rows as a pointer, and the table 165 is connected to the two rows having the foreign key FK2 of the table 161 by an inverse index of the primary key PK4. The table 165 is connected to the row of the primary key PK5 of the lower table 166 using the foreign key FK5 in one row as a pointer, and the table 166 is connected to the row having the foreign key FK5 of the table 165 by an inverse index of the primary key PK5. The table 166 is connected to the row of the primary key PK6 of the lower table 167 using each foreign key FK6 in the three rows as a pointer, and the table 167 is connected to the three rows having the foreign key FK6 of the table 166 by an inverse index of the primary key PK6. The table 167 is connected to the row of the primary key PK7 of the lower table 168 using each foreign key FK7 in the two rows as a pointer, and the table 168 is connected to the two rows having the foreign key FK7 of the table 167 by an inverse index of the primary key PK7.

In this case, since the primary key of each row in each table uniquely determines that row, an object ID as a foreign key in an upper table forming an arbitrary hierarchy with a lower table functions as a pointer directly and uniquely designating a target row in the lower table. That is, an object ID as a foreign key in an upper table forming an arbitrary hierarchy with a lower table functions as a pointer directly and uniquely designating a target row in the lower table without searching it. Similarly, an object ID indicating a row in the lower table functions as a pointer directly designating the row without searching all rows that have foreign keys designating the target row in the upper table.

Therefore, the data structure is formed by connecting a lower table and another lower table through at least one upper table on a chain and in a bidirectional manner. In any case, the physical address of the row of a table to be referred to can be quickly computed by a simple equation of a+b×n.

FIG. 18B shows the difference between the prior art and the present invention in relationship to the substance of a table and index/pointer. In the prior art, a natural object is the substance of a table, and an index and a pointer are added to the natural object to facilitate the data retrieval. On the other hand, according to the present invention, the object ID converted by the object conversion unit 13 is the substance of a table, and the object ID itself is a pointer to the row of another table.

As described above, the database management system 10 according to the first embodiment of the present invention comprises the object conversion unit 13 and the database 11, and provides a service for an external unit by executing a process request issued from the user interface 20 to perform data manipulations by adding, deleting, and updating data on the database 11.

The database 11 stores a table of a hierarchical structure comprising object IDs converted by the object conversion unit 13 as a permanent object for storing data during the period in which the system is utilized in either an operation mode in which a service is offered to an external unit, or in an inoperable mode in which a service is stopped. In this case, the table of the hierarchical structure stored in the database 11 has a data structure formed by connecting a lower table and another lower table through at least one upper table on a chain and in a bidirectional manner by forming a pointer with which an object ID that is a foreign key of a table between a lower table and an upper table forming a hierarchical level directly designates a row of another table.

Therefore, according to the database management system 10 of the present invention, a plurality of tables of a hierarchical structure form indicate a structure of data connected on a chain in a bidirectional manner. Therefore, when a foreign key of a table refers to a target row in another table, the target row is directly accessed without searching other tables, thereby performing high-speed data processing.

Since a high-speed process can be performed in response to various data manipulations requests from a user interface, it is not necessary to generate a new table for holding redundant data for high-speed processing or retrieve data and aggregate data in advance of operation requests. As a result, personnel resources and a long development period for the development of the programs are not necessary, thereby reducing the cost of the system and shortening the system development time.

Furthermore, since there is no need to perform tuning operations which largely depend on the ability and technique of each engineer, the universality and the inheritance of the system can be maintained. As a result, a scalable database management system capable of flexibly responding to future needs in possible.

Additionally, in a data structure in which a plurality of tables of a hierarchical structure is connected on a chain and in a bidirectional manner, the foreign key of one table has the same value as the composite object ID in the table referred to by the foreign key, and, using the composite object ID as a pointer, the foreign key uniquely designates the row of another table. That is, as shown in FIG. 14A, the foreign key “1” of the organization ID 62 in the client table 60, which is one table, has the same value of “1” as the composite object ID of the object ID “0” of the department ID 71 and the object ID “1” of the subdepartment ID 72 in the organization table 70, which another other table, and the second row of the organization table 70 is designated using the composite object ID “1” as a pointer.

Furthermore, using a foreign key of a table as a pointer, a row can be uniquely designated by a composite object ID of another table. For example, in the client discount table (not shown) formed by three columns of a merchandise ID, a client ID, and a unit price ID, a row is uniquely designated using a composite object ID of two columns of a merchandise ID and a client ID as a pointer. Otherwise, a row can be uniquely designated using a composite object ID of a date ID and a merchandise ID as a pointer in a period-limited discount table (not shown) formed by three columns of a date ID, a merchandise ID, and a unit price ID. Otherwise, a row can be uniquely designated using a composite object ID of three columns of a date ID, a merchandise ID, and a client ID as a pointer in a period-limited discount table by client (not shown) Therefore, although the primary key of a table referred to by a number of columns for unique designation uses the foreign key of another table as a pointer, the composite object ID of the number of columns has the same value as the foreign key. Therefore, a row of the table to be referred to can be directly accessed using the foreign key as a pointer.

Furthermore, the object conversion unit 13 in the database management system 10 according to the present invention converts each of a plurality of natural objects and each of a plurality of object IDs formed by consecutive integers can be uniquely and bidirectionally converted.

FIG. 19A shows the difference between the prior art and the present invention in temporary object (period in which services are offered) and permanent object (period including the time when services stopped). In the first prior art, a temporary object is formed by natural objects, and a permanent object is formed by compressed natural objects. In the second prior art, a temporary object is formed by object IDs obtained by converting a part of natural objects, and a permanent object is formed by compressed natural objects.

In the first and second prior art, permanent objects are formed by compressed natural objects. However, in the operation mode, data processing is performed with the original data length (that is, by decompressing the data). Therefore, the required capacity for the main memory is not reduced. In the second prior art (no database), a part of a temporary object is converted into an object ID. However, in the operation mode, it is necessary for parts of the natural objects to be converted into object IDs. Therefore, the data processing to be performed at a process request from a user interface is delayed. Furthermore, since permanent objects are not converted into object IDs, a process of retrieving a row of each table is required, thereby disabling high-speed data processing.

On the other hand, in the database management system according to the first embodiment of the present invention, both temporary objects and permanent objects are formed by object IDs. FIG. 19B shows a practical example of converting a natural object into an object ID. In FIG. 19B, as each attribute of a merchandise supplier table, when a 10-digit merchandise code represents the maximum of a hundred thousand types of merchandise, an 8-digit supplier code represents the maximum of a hundred thousand types of suppliers, an 8-digit type represents the maximum of one thousand types, and a 4-byte (32-bit) unit price represents 1 through 1000 amount of money, natural objects of respectively 10, 8, 8, and 4 bytes are required. This adds up to 30 bytes.

When the natural objects are converted into object IDs, as each attribute of a merchandise supplier table, and when a 10-digit merchandise code represents the maximum of a hundred thousand types of merchandise, an 8-digit supplier code represents the maximum of a hundred thousand types of suppliers, an 8-digit type represents the maximum of one thousand types, and a 4-byte (32-bit) unit price represents 1 through 1000 amount of money, the number of bits is to be set depending on the type. Therefore, the merchandise code is 17 bits long, the supplier code is 14 bits long, the type code is 10 bits long, and the price code is 10 bits long. Thus, a total of 51 bits, that is, 7 bytes, are required. That is, as compared with a total of 30 bytes forming the merchandise supplier table of natural objects, the storage area of the database 11 can be reduced by about 77%.

That is, the object conversion unit 13 in the database management system 10 according to the present invention does not convert natural objects into the object IDs of the corresponding number, but into the object IDs of the corresponding type.

Therefore, since a natural object of a larger volume of data is converted into an object ID of an integer of a very small volume of data, the requirements for the capacity of the database comprising external storage media such as a hard disk, etc. can be smaller. As a result, the cost of a system can be considerably reduced. Furthermore, since a target object ID of a very small volume of data probably resides in the main memory or cache memory, the access frequency to an external storage medium such as a hard disk, etc. becomes very low, thereby performing high-speed data processing.

Described below is the comparison between the performance of the relational database according to the present invention and the performance of the relational database according to the prior art. As a conventional relational database to be compared, the system of a well-known company widely used in the USA, Europe, Japan, and other countries as the prior art is adopted. In this case, the most reliable “TPC/D benchmark test” is used in comparing the performance of the relational database in the database management system according to the first embodiment of the present invention and the performance of the relational database of the well-known company.

The TPC/D benchmark test is a benchmark tool for analysis of a database by the Transaction Processing Performance Council, and is used in checking the retrieval using a complicated database for a decision making support, etc. Since a user conducts this TPC/D benchmark test as a measure for evaluation of a product of each vendor, various famous vendors compete for the latest data on the respective TPC home pages.

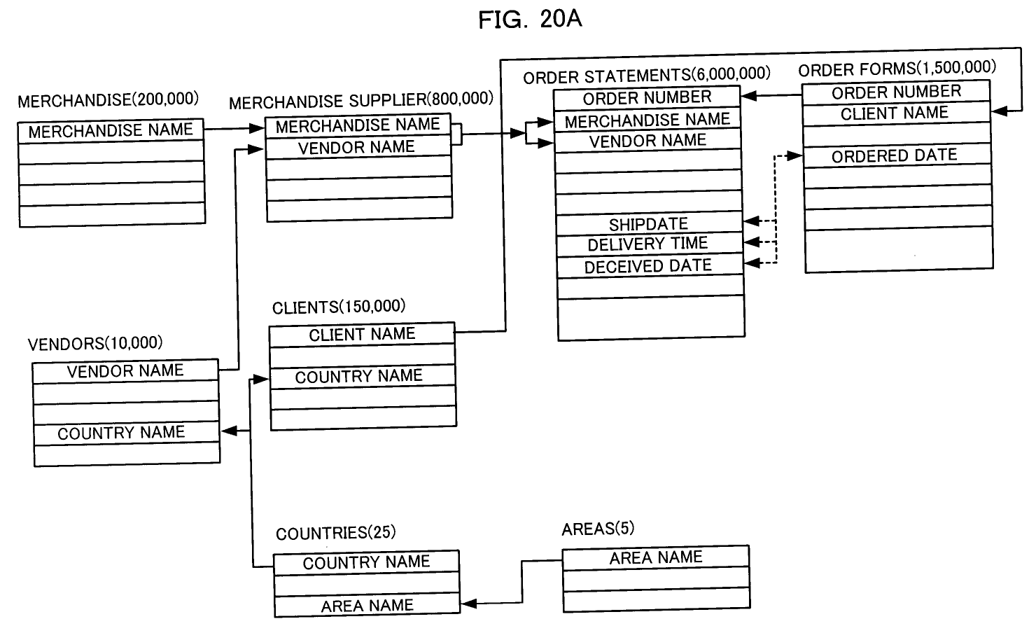

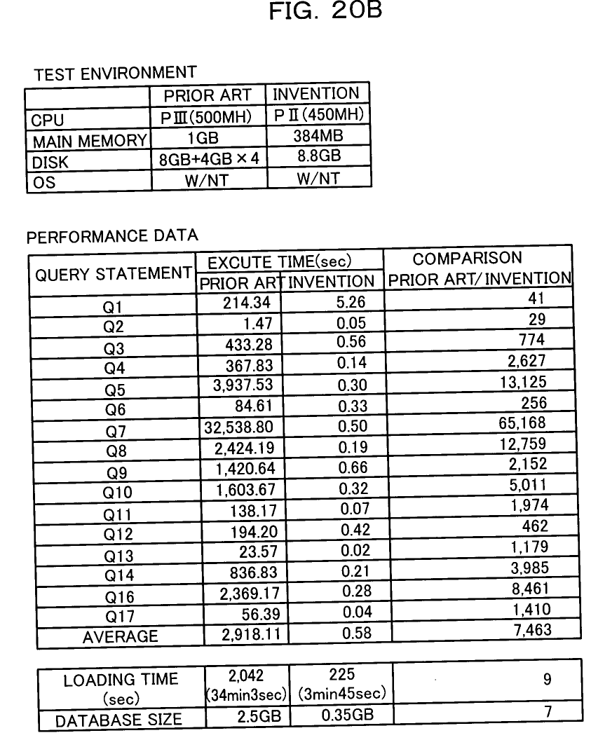

FIG. 20A shows the outline of the TPC/D benchmark test. In this test, using two hundred thousand merchandise tables, ten thousand vendors tables, eighty thousand merchandise supplier tables, fifteen thousand client tables, six million order statement tables, and one and half million order form tables, the run time taken for the transaction processing performed in response to the inquiries from Q1 to Q17 is counted.

FIG. 20B shows the result of the TPC/D benchmark test. As clearly shown by FIG. 20B, the run time of the transaction processing of the present invention performed in response to all inquiries is much shorter than the run time in the prior art. In simply comparing the average runtime speed in the inquiry performance, it is about 7,000 times higher (29 times through 65, 168 times). In the comparison of database loading performance, it is about 9 times higher. In the comparison of database size, it is about 1/7 of the prior art. Among the comparison results, the result obtained by the present invention in comparison with the runtime speed of the prior art relating to the inquiry Q7 is a 65,168 time higher speed. Considering the highly evaluated relational database of the well-known company used in the performance test, it is obvious that the relational database according to the present invention has remarkable performance.

The data conversion method by the object conversion unit 13 according to the first embodiment of the present invention is described below by referring to the second through eighth embodiments.

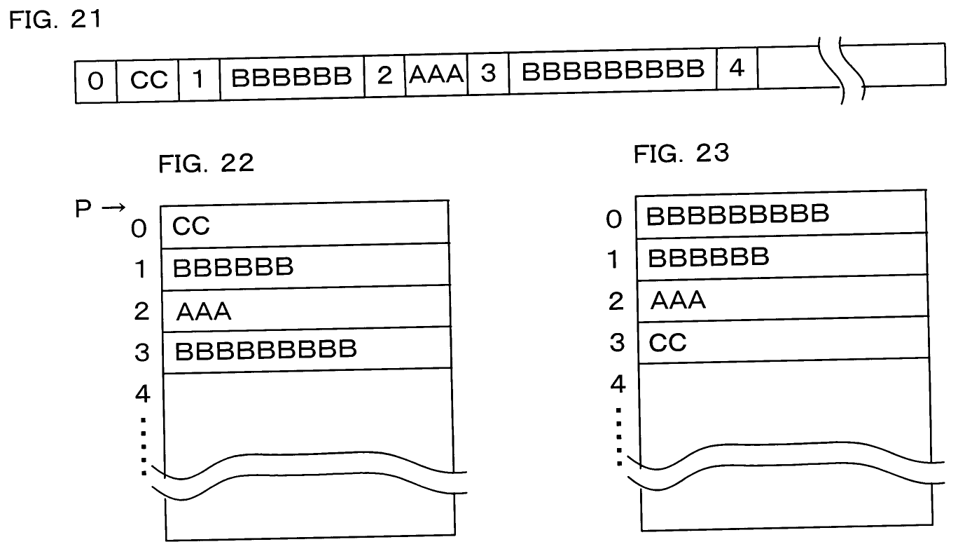

FIG. 21 shows the data conversion method of the object conversion unit 13 according to the second embodiment. The data structure of the object conversion unit in the embodiment is applied when rows have different byte sizes. As shown in FIG. 21, the data structure is a linked list. That is, the integer starting with “0” is followed by natural objects.

When the object conversion unit 13 converts a natural object into an object ID, it searches the linked list, and outputs an integer immediately before a matching natural object as an object ID to a processing unit 12. Additionally, when the object conversion unit 13 converts an object ID into an natural object, it searches the list, and outputs a natural object immediately after a matching object ID to the processing unit 12.

In FIG. 21, for example, when the natural object “AAA” is converted into an object ID, the list is searched, and the integer “2” immediately before the matching natural object “AAA” is output as an object ID. Furthermore, when the object ID “0” is converted into a natural object, the list is searched, and the natural object “CC”, immediately after the matching integer “0”, is output. When the number of pieces of data is n, the frequency counted when a successful search can be performed is an average value of n/2.

Thus, according to the second embodiment, the object conversion unit 13 of the data structure in a linked list format can be applied to a case in which rows have different byte sizes to provide a relational database which can be realized to perform a high-speed process in response to various process requests from a user interface, and can be formed by a database of small capacity requirements.

Described below is the third embodiment of the present invention. FIG. 22 shows the data conversion method of the object conversion unit 13 according to the third embodiment of the present invention. The data conversion method according to this embodiment is array formatted as shown in FIG. 22.

When the object conversion unit 13 converts a natural object into an object ID, it sequentially searches the array from the leading address in the linear search method (also referred to as a serial search, or sequential search method), and outputs an object ID corresponding to a matching natural object to the processing unit 12. Furthermore, when the object conversion unit 13 converts an object ID into a natural object, it computes the address AD of the object ID by the following equation, and outputs the quickly retrieved natural object to the processing unit 12.

AD=P+S*n

where P indicates the leading address of the array, S indicates the byte size of the row of the array, and n indicates the value of the object ID to be processed.

As described above, according to the third embodiment, the linear search method is applied in the array format data conversion method to provide a relational database which can be realized to perform a high-speed process in response to various process requests from a user interface, and can be formed by a database of small capacity requirements.

Described below is the fourth embodiment of the present invention. In the above-mentioned third embodiment, an object ID can be quickly converted into a natural object, but it takes a longer time to convert a natural object into an object ID because the linear search method is used. The fourth embodiment is improved from the third embodiment so that a natural object can be quickly converted into an object ID.

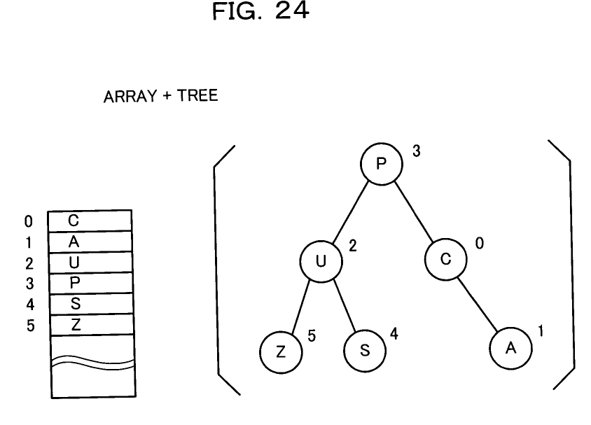

For a higher-speed process, the algorithm of the binary search method is used. The binary search method is one of the table index methods for retrieving a target item from a list, and can be executed by dividing a group of items into two portions having no common elements with each other, determining to which portion the target item belongs, and repeating the dividing process each time. To apply the binary search method, it is necessary to sort data in an array. Normally, data (in this case, natural objects) is sorted in order from the largest to the smallest. FIG. 23 shows the data sorted array. In the data sorted array, the row of a corresponding natural object is retrieved by repeatedly performing the process of dividing a search area into two portions, thereby retrieving the row of a corresponding natural object. When a row is added, the sorting process is repeated again.

As described above, according to the fourth embodiment, the binary search method is applied in the array format data conversion method to provide a relational database which can be realized to perform a high-speed process in response to various process requests from a user interface, and can be formed by a database of small capacity requirements.

Described below is the fifth embodiment of the present invention. In the above-mentioned fourth embodiment, it is necessary to perform a sorting process each time a row is added. However, in the fifth embodiment, a table for added natural objects is provided in addition to the sorted array. When a natural object is added, the natural object is associated with a converted object ID, and stored in the table. When there is a large number of rows in the table, it takes a long time to perform the retrieval, but as compared with the number of rows initially stored when the system is generated, the rate of increase of the row added by a common user interface is not so high. When the number of rows accumulated in the table becomes large with the progress of time, the sorting process is to be performed again with the sorted array and the data in the table.

As described above, according to the fifth embodiment, the binary search method is applied by providing an additional table for natural objects to be added in the array format data conversion method to provide a relational database which can be realized to perform a high-speed process in response to various process requests from a user interface, and can be formed by a database of small capacity requirements.

The sixth embodiment of the present invention is described below. In this embodiment, data is retrieved using an array of a B tree index. A B tree index is also referred to as a balanced tree index, and is a data retrieval method for accessing specified data at random. The B tree index has a 3-level structure of a root block, a plurality of node blocks, and a plurality of leaf blocks. Furthermore, the data structure is designed to have almost an equal amount of data in each of the node blocks and the leaf blocks. Additionally, each of the root block and the node blocks is formed by a record portion and an index portion, and the record portion stores natural objects. The index portion stores a pointer pointing to the record positions of its blocks, and a pointer pointing to the record positions of lower node blocks or leaf blocks.

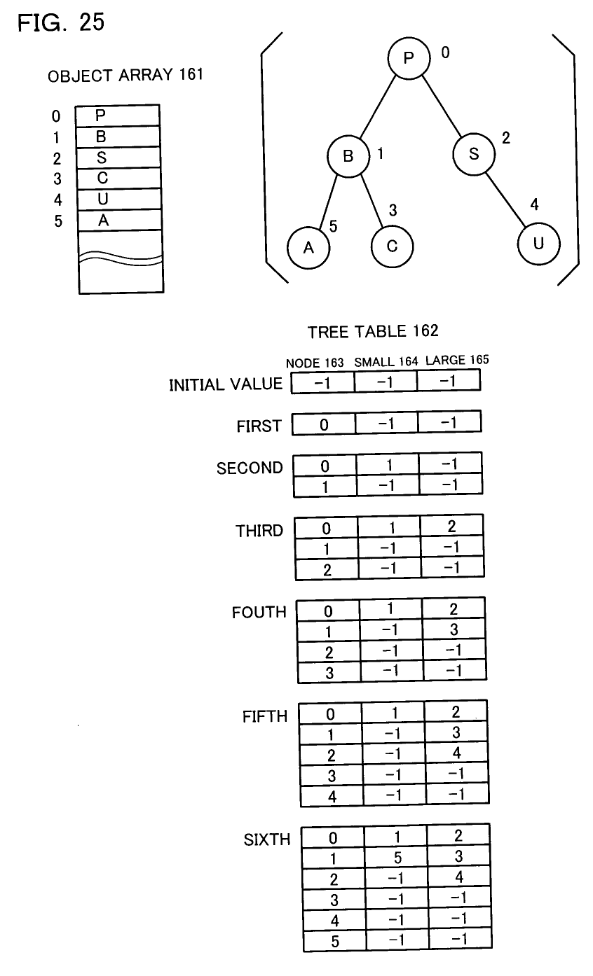

FIG. 24 shows an array of the B tree index according to the present embodiment. FIG. 25 shows an object array 161 of the B tree storing natural objects in the storing order, the images of the B tree in [], and the tree table 162. The columns forming each row in the table 162 comprise a node 163, small 164, and large 165. The node 163 stores a pointer value indicating the storage position of a stored natural object. The small 164 and the large 165 store the pointer values of the natural objects positioned immediately below the node 163 in each tree.

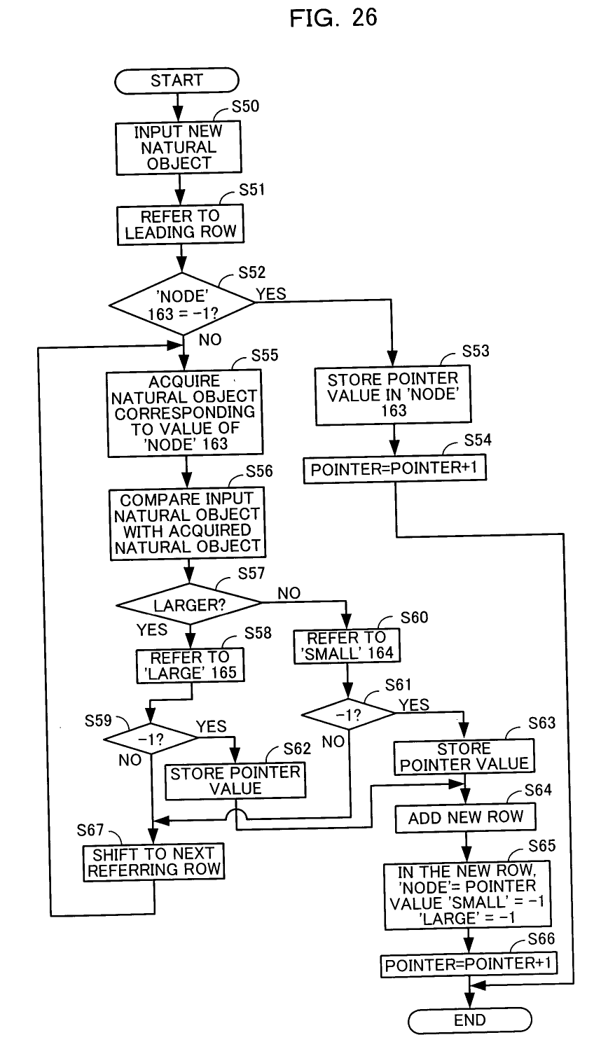

Described below is the process of storing a natural object. FIG. 26 is a flowchart of the process of generating the tree table 162 shown in FIG. 25. Although not shown in FIG. 26, in the initial state in which nothing is stored, the initial value of “−1” is stored in each column in the leading row of the tree table 162 in the flowchart. The value of “−1” in this case indicates that the column is “vacant”. The initial value can be any other value other than “−1” which is being not used as a pointer value. For example, it can be “NULL” indicating “vacant”. The initial value of the pointer is set to 0.

The flowchart shown in FIG. 26 is executed each time a natural object is newly stored. First, when a new natural object is input (step S50), the “node” 163 in the leading row of the table 162 is referred to (step S51), and it is determined whether or not the value is −1 (step S52). If the value is −1, the column is vacant, and the pointer value indicating the storage position of the new natural object is stored in the “node” 163 of the leading row (step S53). Then, 1 is added to the pointer value (step S54), thereby terminating the flowchart.

If the value of the “node” 163 is not “−1” in step S52, a natural object corresponding to the value of the “node” 163 is obtained (step S55). Then, sizes are compared between the new natural object and the obtained natural object (step S56). In the comparison process, it is determined whether or not the new natural object has a larger value than the obtained natural object (step S57). If the new natural object has a larger value than the obtained natural object, then the value of the column “large” 165 of the object table 162 is referred to (step S58). Then, it is determined whether or not the referenced value is “−1” (step S59). If the new natural object has a smaller value that the obtained natural object in step S57, the value of the column “small” 164 of the object table 162 is referred to (step S60). Then it is determined whether or not the reference value is “−1” (step S61).

If the value of the referenced column “large” 165 is “−1” in step S59, then the pointer value is stored in the column “large” 165 (step S62). If the value of the referenced column “small” 164 is “−1” in step S61, then the value of the pointer is stored in the column “small” 164 (step S63). After the value of the pointer is stored in step S62 or S63, a new row is added (step S64), and the pointer value is stored in the “node” 163 of the new row, and “−1” is stored in “large” 165 and “small” 164 (step S65). Then, 1 is added to the pointer value (step S66), thereby terminating the flowchart. If the value of the column “large” 165 is not “−1” in step S59, or the value of the column “small” 164 is not “−1” in step S61, then control is passed to the next row to be referred to (step S67). Afterwards, control is passed to step S55, and the above-mentioned process is repeated.

A practical example of the case in which a natural object is stored is described below by referring to the object table, tree table shown in FIG. 25 and the flowchart shown in FIG. 26. For simple explanation, the natural object in this case is a simple character, and the case in which “P”, “B”, “S”, “C”, “U”, and “A” are stored is described below as a storing process according to the present embodiment. The collation of characters is performed in alphabetical order with the character “A” defined as the smallest value and “Z” as the largest value. In the object array 161, the integers starting with “0” (0, 1, 2, 3, 4, 5, . . . ) are the pointers indicating the storage position of each natural object.

When the first natural object “P” is stored, the initial value of “node” 163 is “−1” in the first row of the object table 162 shown in FIG. 25, and therefore, “YES” is determined in step S52. In step S53, the pointer value “0” is stored in the column of “node” 163. In step S54, the pointer value is increased from “0” to “1”, thereby terminating the flowchart. As a result, as shown by the first row in FIG. 25, the column of the “node” 163 indicates “0”. Therefore, the tree table 162 enters the first state shown in FIG. 25.

Since the value of the “node” 163 is “0” not “−1” when the natural object “B” is stored, “NO” is determined in step S52, control is passed to step S55, and the natural object “P” corresponding to the value “0” of “node” 163 is obtained. Then, in step S56, “B” is collated with “P”. In this case, “B”<“P”. Therefore, “NO” is determined in step S57, control is passed to step S60, and the column of the “small” 164 is referred to. Since the value of “small” 164 is “−1” in this case, “YES” is determined in step S61, control is passed to step S63, and the pointer value of “1” is stored in “small” 164. Then, in step S64, a new row is added as the second row. In step S65, the pointer value “1” is stored in the “node” 163 of the new row, and “−1” is stored in the column “large” 165 and the column “small” 164. Then, the pointer value is increased from “1” to “2”, thereby terminating the flowchart. Therefore, the tree table 162 enters the second state shown in FIG. 25.

When the natural object “S” is stored, the same processes as the natural object “B” are performed up to step S56. In step S57, since “S” is larger than “P” (“S”>“P”), “YES” is determined. As a result, control is passed to step S58, and the column of “large” 165 is referred to. Since the value of “large” 165 is “−1”, “YES” is determined in step S59, control is passed to step S62, and the pointer value “2” is stored in “large” 165. Then, in step S64, a new row is added as the third row. In step S65, the pointer value “2” is stored in the “node” 163 of the new row, and “−1” is stored in the column “large” 165 and the column “small” 164. Afterwards, the pointer value is increased from “2” to “3” in step S66, thereby terminating the flowchart. Therefore, the tree table 162 enters the third state in FIG. 25.

When the natural object “C” is stored, the same processes are performed up to step S56 as in the cases of the above-mentioned natural objects. Since “C” is smaller than “P” (“C”<“P”), “NO” is determined in step S57. As a result, “small” 164 is referred to in step S60. Since the value of the column “small” 164 is ‘2’, “NO” is determined in step S61. As a result, control is passed to step S67, and the next row to be referred to, that is, the second row, is referred to. Then, control is passed to step S55, and the natural object “B” corresponding to the value “1” of “node” 163 is obtained. Then, the new “C” and the obtained “B” is compared in step S56. In step S57, “YES” is determined because “C” is larger than “B” (“C”>“B”). As a result, control is passed to step S58, and the column of “large” 165 is referred to. Since the value of “large” 165 is “−1”, “YES” is determined in step S59, control is passed to step S62, and the pointer value “3” is stored in “large” 165. Then, in step S64, a new row is added as the fourth row. Then, the pointer value “3” is stored in the “node” 163 of the new row in step S65, and “−1” is stored in the column “large” 165 and column “small” 164. Afterwards, in step S66, the pointer value in increased from “3” to “4”, thereby terminating the flowchart. Therefore, the tree table 162 enters the fourth state in FIG. 25.

The same processes are performed on the next new natural object “U” and the pointer value is stored. Therefore, the tree table 162 enters the fifth state shown in FIG. 25. When the next new natural object “A” is stored, the same processes are performed, and the pointer value is stored. Therefore, the tree table 162 enters the sixth state shown in FIG. 25. Afterwards, each time a new natural object is stored, the flowchart is executed and the pointer value is sequentially stored in the tree table 162.

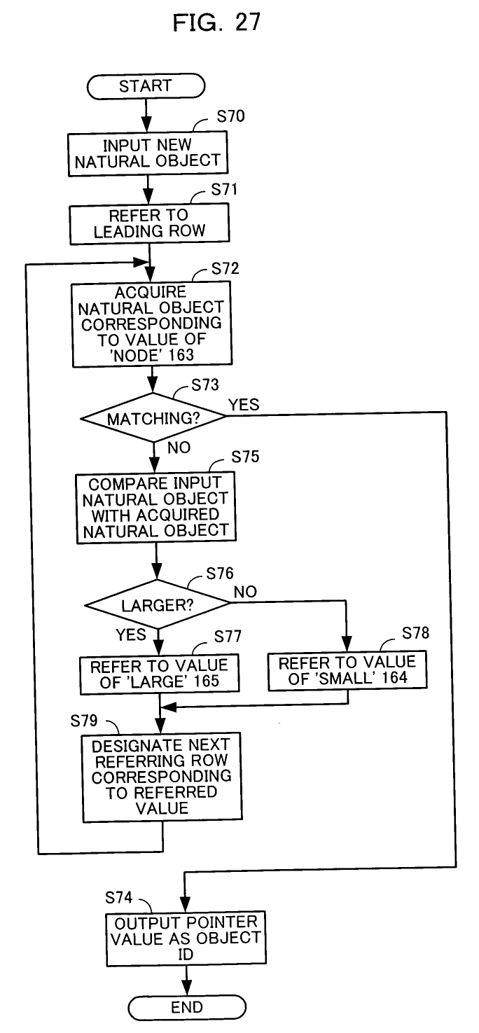

Next, the process of converting a natural object into an object ID by the object conversion unit 13 according to the present embodiment is explained below. FIG. 27 is a flowchart of the process of converting a natural object into an object ID. When, for example, a user interface, etc. issues a process request on a natural object, and a new natural object is input (step S70), the leading row of the table 162 shown in FIG. 25 is referred to (step S71). Then, a natural object corresponding to the pointer value of the “node” 163 of the referenced row is obtained (step S72). Then, it is determined whether or not the natural object in the converting process matches the obtained natural object (step S73). If they match, the reference pointer value is output as an object ID to a processing unit (step S74).

If the natural object in the converting process does not match the obtained natural object in step S73, then the two natural objects are collated (step S75), and it is determined whether or not the natural object in the converting process is larger than the obtained natural object (step S76). If the former is larger, the pointer value of “large” 165 of the referenced row is referred to (step S77). If the former is smaller, the pointer value of “small” 164 of the referenced row is referred to (step S78). Whichever pointer value is referred to, the row pointed to by the pointer value is to be referenced (step S79). Then, control is passed to step S72, and the natural object corresponding to the pointer value of the “node” 163 in the row pointed to by the pointer value is obtained. Afterwards, it is determined in step S73 whether or not the natural object in the converting process matches the obtained natural object. If they do not match, the loop processing from step S75 to S72 is repeated. If they match, then control is passed to step S74, and the referenced pointer value is output as an object ID to the processing unit.

Then, the case in which a natural object “U” is converted into an object ID is described as an example of a converting process according to the present embodiment by referring to the object array 161 shown in FIG. 25, the sixth tree table 162, and the flowchart shown in FIG. 27. In step S71, the leading row of the tree table 162 is referred to. In step S72, the natural object “P” corresponding to the pointer value “0” of the “node” 163 in the leading row is obtained. Since “U” does not match “P”, “NO” is determined in step S73, control is passed to step S75, and “U” is collated with “P”. In this case, since “U” is larger than “P” (“U”>“P”), “YES” is determined in step S76, control is passed to step S77, and the pointer value “2” of “large” 165 in the leading row is referred to. Therefore, the row of the pointer value “2”, that is, the third row in the table 162 shown in FIG. 25, is referred to in step S79.

Then, in step S72, the natural object “S” corresponding to the pointer value “2” of the “node” 163 in the third row is obtained. Also in this case, the “U” does not match “S”, and “U” is larger than “S” (“U”>“S”). Therefore, control is passed to steps S75, S77, and S79, and the row of the pointer value “4”, that is, the fifth row in the tree table 162 shown in FIG. 25, is referred to.

Then, in step S72, the natural object “U” corresponding to the pointer value “4” of the “node” 163 in the fifth row is obtained. In this case, the “U” to be converted matches the obtained “U”. Therefore, “YES” is determined in step S73, control is passed to step S74, and the pointer value “4” is output as an object ID to the processing unit.

As described above, according to the sixth embodiment, the data conversion method using a B tree index array can provide a relational database which can be realized to perform a high-speed process in response to various process requests from a user interface, and can be formed by a database of small capacity requirements.

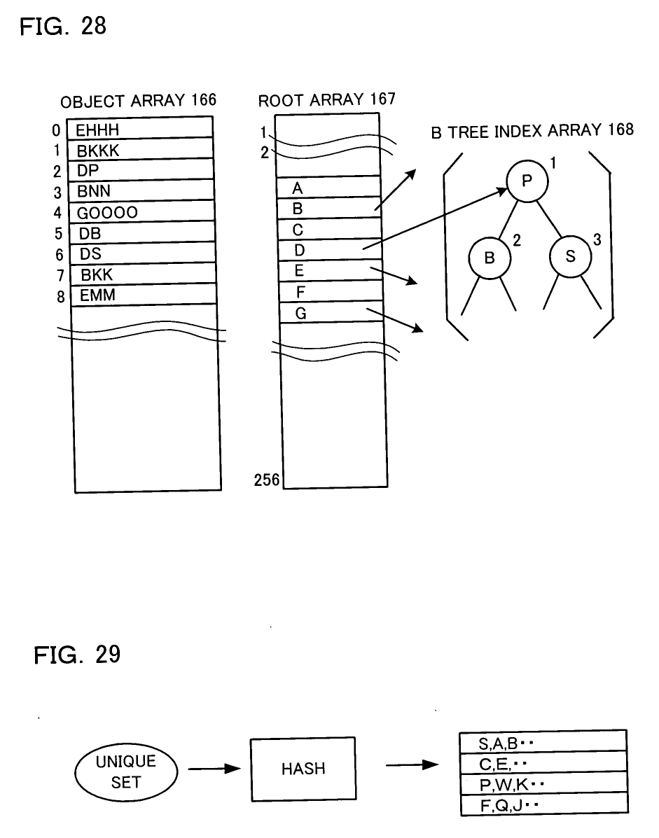

Described below is the seventh embodiment of the present invention. In this embodiment, the object conversion unit having a data structure of an array format and a B tree index is the same as that used in the above-mentioned sixth embodiment. However, the seventh embodiment is different from the sixth embodiment in that an array of a plurality of B tree indexes is used. FIG. 28 shows an array with a plurality of B tree indexes, and shows an object array 166, a root array 167, and a B tree index array 168 corresponding to the root array. For example, an array of a plurality of B tree indexes can be generated for each group process by sorting natural objects into a plurality of group processes. There are various methods for sorting natural objects. For example, when natural objects are character strings of alphabetical characters, the natural objects having the same leading characters of character strings are sorted into the same group. Furthermore, a root array is generated with each leading character associated with each grouping process.

When the object conversion unit 13 stores or converts a natural object at a process request from a user interface, it first refers to the root array 167 using the leading character of the natural object. Then, the array of the B tree index in the group processing corresponding to the root array 167 is executed in the same method as the sixth embodiment.

As described above, according to the seventh embodiment, the data conversion method using an array of a plurality of B tree indexes can also provide a relational database which can be realized to perform a high-speed process in response to various process requests from a user interface, and can be formed by a database of small capacity requirements.

Described below is the eighth embodiment of the present invention. In this embodiment, a natural object is stored or converted in the hash search method at a process request from a user interface. In the hash search method, a predetermined arithmetic operation is performed on a part (keyword) of a natural object, and the result is used as a storage address of a storage area of the memory, thereby quickly reading data in the conversion process. Furthermore, since the range of the value of a keyword can be narrowed, the memory can be saved.

FIG. 29 shows the concept of the method of sorting in the hash search method the natural objects which form a unique group. For example, the natural objects having equal values of the leading bytes can be sorted for group processing. In this case, there is the possibility of the conflict for the same arithmetic result (storage address) between different natural objects. Therefore, it is necessary to select an arithmetic such that the possibility of the conflict can be reduced. It is important how to determine a storage address replacing the conflicting storage address.

As described above, according to the eighth embodiment of the present invention, the data conversion method for conversion between a natural object and an object ID can also provide a relational database which can be realized to perform a high-speed process in response to various process requests from a user interface, and can be formed by a database of small capacity requirements.

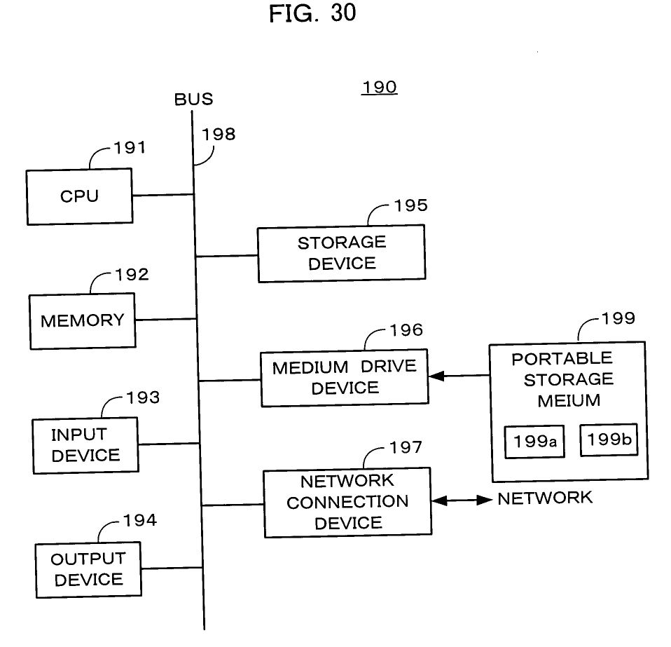

FIG. 30 shows the configuration of the hardware of the database management system and a computer system 190 for realizing a relational database comprising a database according to the above-mentioned embodiments. As shown in FIG. 30, the computer system 190 comprises a CPU 191, memory 192, an input device 193, an output device 194, a storage device 195, a medium drive device 196, and a network connection device 197 connected through a bus 198. Furthermore, a portable storage medium 199 is inserted into the medium drive device 196.

Described below are functions of each component and practical means. The CPU 191 is an arithmetic operation unit for updating data, etc. by executing a program for control of the computer system 190. The memory 192 comprises RAM, etc., and temporarily stores a program and data stored in the storage device 195 or the portable storage medium 199. That is, the CPU 191 performs a process according to each of the above-mentioned embodiments using the program and the data read to the memory 192. The input device 193 can be, for example, a keyboard, a mouse, a touch panel, etc., and is optionally used. The output device 194 can be, for example, a display, a printer, a data storage unit, etc., and is optionally used. The storage device 195 can be, for example, a hard disk device, semiconductor memory with a backup battery, non-volatile semiconductor memory such as flash memory, etc., and stores a program and data to be processed executed by the CPU 191. The database 11 shown in FIG. 6 can comprise the storage device 195, or an external storage device not shown in the attached drawings. Furthermore, the portable storage medium 199 can also store a program executed by the CPU 191 and data to be processed. The medium drive device 196 controls an inserted portable storage medium 199 to read a stored program, and read or write data. The portable storage medium 199 can be a portable storage medium having a predetermined storage capacity, for example, CD-ROM 199a, a FD (flexible disk) 199b, a DVD, a magneto-optical disk, etc. not shown in the attached drawings. The network connection device 197 can be connected to a network such as the Internet, etc. and communicate a program and data with an external information processing device.

The configuration of the computer system 190 shown in FIG. 30 is an embodiment, and the hardware configuration of the database management system and a computer system for realizing a relational database according to the present invention is not limited to the configuration shown in FIG. 30. For example, a plurality of CPUs can also be acceptable. In this case, a plurality of CPUs can execute a program and process data equally among them, or by functioning as co-processors operating as a subordinate to another.

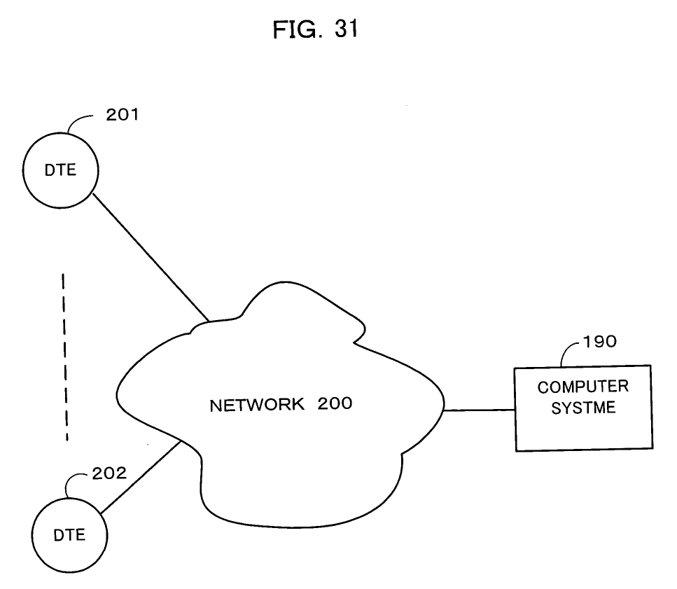

FIG. 31 shows the configuration of downloading a program and data from an external information processing device through a network. As shown in FIG. 31, the computer system 190 can be connected to any of the information processing device in a plurality of external information processing devices 201, 202, . . . through the network 200 by cable or by wireless so that the program executed by the CPU 191 or the processed data can be downloaded.

The invention of the database management system, that is, the invention of the device, has been explained above. However, as it is obvious from the operation in the above-mentioned embodiments, the invention of a data structure generation method with the database management system can also be realized.

The data structure generation method according to the present invention converts each of a plurality of natural objects and each of a plurality of object IDs comprising consecutive integers in a unique relationship and a bidirectional manner, and stores a table of a hierarchical structure comprising an object ID converted from a natural object as a permanent object holding data during the period in which the system is utilized in either an operation mode in which a service is offered to an external unit, or in an inoperable mode in which a service is stopped. In this case, it is stored in a data structure formed by connecting a lower table and another lower table through at least one upper table on a chain and in a bidirectional manner by configuring a pointer with which an object ID that is a foreign key of a table between a lower table and an upper table forming a hierarchical level directly designates a row of another table.

In this case, the data structure generation method can be realized by a program stored in the storage device 195, a program downloaded from the portable storage medium 199 to the database management system 10, or a program downloaded from an external information processing device 201 or 202 through a network 200 to the database management system 10.

Furthermore, since the database 11 is a storage medium storing a data structure including a table of a characteristic hierarchical structure, it configures an invention as a storage medium.

A storage medium according to the present invention stores a table of a hierarchical structure comprising a plurality of object IDs formed by consecutive integers converted from a plurality of natural objects in a unique relationship as permanent objects holding data, during the period in which the system is utilized in either an operation mode in which a service is offered to an external unit. The stored tables of the hierarchical structure have a data structure formed by connecting a lower table and another lower table through at least one upper table on a chain and in a bidirectional manner by forming a pointer with which an object ID that is a foreign key of a table between a lower table and an upper table forming a hierarchical level directly designates a row of another table.

In the above-mentioned embodiment, the data structure of object IDs is formed by an arithmetic progression which is consecutive data uniquely computable based on the arithmetic rules of addition and subtraction. However, the data structure can be formed by consecutive data according to other rules. For example, the data can be consecutive and uniquely computable according to an arithmetic rule other than addition or subtraction, that is, multiplication and division, or can be a root value or accumulated value indicating consecutive data based on an arithmetic rule of an exponential function and a logarithm function. Otherwise, it can be consecutive data according to a language rule such as alphabetical or Japanese characters. That is, the data structure can be formed by consecutive data according to a predetermined rule.

What is claimed is:

1. A database management system, comprising:
a conversion unit for assigning an object ID which is a unique value to each natural object which is information to be manipulated and used by a user, and bidirectionally converting the natural object and the object ID one to one; and
a database unit for storing the object ID as an entity of a table, wherein
said conversion unit and said database unit are held as a permanent object; and a data manipulating process is performed using the object ID.

2. A database management system, comprising:
a conversion unit for assigning an object ID which is a unique value to each natural object which is information to be manipulated and used by a user, and bidirectionally converting the natural object and the object ID one to one; and
a database unit for storing a plurality of tables storing the object ID as an entity of a table having a database structure in which a direct link to a record among related tables can be obtained by the object ID.

3. The system according to claim 2, wherein
said link among the related tables refers to that among the table having external reference relationship, and an object ID of a foreign key of a reference-from table is a value directly indicating a position of a record of a reference-to table.

4. The system according to claim 3, wherein
said conversion unit bidirectionally converts each natural object and object ID belonging to each object type, and assigning the object ID to each natural object in an order of entry consecutively at equal intervals.

5. The system according to claim 3, wherein
when the object ID is assigned as a natural number starting from 0, said conversion unit computes a position of the record of a reference-to table using an object ID of a foreign key of the reference-from table by a following equation (1)
position of corresponding record (physical address)=a+b*n (1)
(a: leading address of reference-to table, b: byte size of record of reference-to table, n: value of foreign key).

6. The system according to claim 4, wherein
when a natural object which belongs to an object type corresponding to a primary key of the table, and is to be converted has been entered in a record adding process to any of the tables, or when a natural object which belongs to an object type corresponding to a foreign key of the table, and is to be converted has not been entered, then said conversion unit does not allow the record adding process to be performed.

7. The system according to claim 3, wherein
said conversion unit assigns an object ID associated one to one to a complex natural object corresponding to the complex key to a foreign key of a table which is a reference-to table having a complex key as a primary key.

8. The system according to claim 3, wherein
said database unit further comprises a reserved reference index indicating an inverse reference of many-to-one external reference relationship by the foreign key.

9. The system according to claim 2, wherein
said conversion unit converts a natural object into an object ID using an array storing natural objects in an ascending order and a tree.

10. The system according to claim 8, wherein
a plurality of trees are provided corresponding to each group obtained by classifying natural objects.

11. A computer-readable storage medium storing, as an entity of a table, each object ID one to one associated with each natural object which is information to be manipulated and used by a user.

12. A computer-readable storage medium for storing a table storing an object ID associated with each natural object in a field of a foreign key, and having a database structure directly indicating a position of a record of a reference-to table by the object ID.

13. A data manipulating method, comprising:
assigning an object ID which is a unique value to each natural object which is information to be manipulated and used by a user while equal intervals can be set consecutively;
storing the object ID as an entity of a table in a database; and
data manipulation is performed while bidirectionally converting a natural object and an object ID one to one using an object ID stored in the database.

14. The method according to claim 13, wherein
a position of the record of a reference-to table is obtained using an object ID of a foreign key in a reference-from table of the database and a predetermined equation as necessary.

15. A database management system which provides a service to an external unit by performing a process corresponding to a request relating to a natural object recognizable in a real world when a request for data manipulations to add, delete, update, etc. data on a database is received from an external unit, comprising:
an object conversion unit converting each of a plurality of natural objects and each of a plurality of object IDs of consecutive data according to a predetermined rule in a unique relationship and a bidirectional manner; and
a database storing a table of a hierarchical structure comprising the object IDs converted by said object conversion unit as a permanent object holding data during a period in which the system is utilized in either an operation mode in which a service is offered to an external unit, or in an inoperable mode in which a service is stopped, wherein
said tables of the hierarchical structure stored in said database are formed by a data structure by connecting a lower table with another lower table through at least one upper table on a chain and in a bidirectional manner by providing an object ID, as a foreign key in an upper table forming an arbitrary hierarchy with a lower table, functioning as a pointer directly and uniquely designating a target row in the lower table without searching the target row, and an object ID, which indicates the row in the lower table, directly designating all rows that have foreign keys designating the target row in the upper table without searching.

16. The system according to claim 15, wherein
said conversion unit converts each of a plurality of natural objects and each of a plurality of object IDs of data uniquely computable in a predetermined arithmetic operation in a unique relationship and a bidirectional manner.

17. The system according to claim 16, wherein
said conversion unit converts each of a plurality of natural objects and each of a plurality of object IDs of data uniquely computable in an arithmetic operation in a unique relationship and a bidirectional manner.

18. The system according to claim 15, wherein
said object conversion unit converts each of a plurality of natural objects and each of a plurality of object IDs of an arithmetic progression starting with “p” at equal intervals of “q” in a unique relationship and a bidirectional manner.

19. The system according to claim 18, wherein
a physical address of a row in a first table connected using as a pointer an object ID of an arbitrary row and column in a second table can be computed by an equation of
physical address=a+b*(n−p)÷q
(where a indicates a leading address of the first table, b indicates a byte size of a row in the first table; and n indicates a value of the object ID).

20. The system according to claim 15, wherein
said object conversion unit converts each of a plurality of natural objects and each of a plurality of object IDs of consecutive integers equal to or larger than “0” in a unique relationship and a bidirectional manner.

21. The system according to claim 20, wherein
a physical address of a row in a first table connected using as a pointer an object ID of an arbitrary row and column in a second table can be computed by an equation of
physical address=a+b*n
(where a indicates a leading address of the first table, b indicates a byte size of a row in the first table; and n indicates a value of the object ID).

22. The system according to claim 15, wherein
when data of an object ID which is a foreign key of the table is a value of “i”, the row of the other table is an i-th row.

23. The system according to claim 15, wherein
said foreign key of the table has the same value as a composite object ID of a plurality of columns in the other table, and uniquely designates a row of the other table using the composite object ID as a pointer.

24. A method of generating a data structure comprising a plurality of steps in a database management system which offers a service to an external unit by executing a process request when a request for data manipulations to add, delete, update, etc. data on a database is received from an external unit relating to a natural object recognizable in a real world, comprising the steps of:
converting each of a plurality of natural objects and each of a plurality of object IDs of consecutive data according to a predetermined rule in a unique relationship and a bidirectional manner; and
storing a database when storing a table of a hierarchical structure comprising the object IDs converted from the natural objects as a permanent object holding data during a period in which the system is utilized in either an operation mode in which a service is offered to an external unit, or in an inoperable mode in which a service is stopped in a data structure by connecting a lower table with another lower table through at least one upper table on a chain and in a bidirectional manner by providing an object ID, as a foreign key in an upper table forming an arbitrary hierarchy with a lower table, functioning as a pointer directly and uniquely designating a target row in the lower table without searching the target row, and an object ID, which indicates the row in the lower table, directly designating all rows that have foreign keys designating the target row in the upper table without searching.

25. The method according to claim 24, wherein
in said step of converting each of the plurality of natural objects and each of the plurality of object IDs in a bidirectional manner, said natural objects are converted using an array and a tree index for storage in a storing order.

26. The method according to claim 25, wherein
in said step of converting each of the plurality of natural objects and each of the plurality of object IDs in a bidirectional manner, said natural objects are converted in a hash search method.

27. The method according to claim 25, wherein
said method is realized by a program downloaded to a database management system from a portable storage medium or a program downloaded to a database management system from an external information processing device through a network.

28. A storage medium storing data to be processed in a database management system, wherein
a table of a hierarchical structure comprising a plurality of object IDs of consecutive data according to a predetermined rule converted in a unique relationship from a plurality of natural objects is stored as a permanent object storing data during a period in which the system is utilized in either an operation mode in which a service is offered to an external unit, or in an inoperable mode in which a service is stopped, and the stored tables of the hierarchical structure have a data structure formed by connecting a lower table with another lower table through at least one upper table on a chain and in a bidirectional manner by providing an object ID, as a foreign key in an upper table forming an arbitrary hierarchy with a lower table, functioning as a pointer directly and uniquely designating a target row in the lower table without searching the target row, and an object ID, which indicates the row in the lower table, directly designating all rows that have foreign keys designating the target row in the upper table without searching.
